(19) United States
(12) Patent Application Publication
(10) Pub. No.: US 2025/0189772 A1
(43) Pub. Date: Jun. 12, 2025

(54) ZOOM LENS AND IMAGE PICKUP APPARATUS

(71) Applicant: CANON KABUSHIKI KAISHA, Tokyo (JP)

(72) Inventor: MAKOTO NAKAHARA, Tochigi (JP)

(21) Appl. No.: 18/930,202

(22) Filed: Oct. 29, 2024

(30) Foreign Application Priority Data
Dec. 6, 2023 (JP) 2023-206073

(51) Int. Cl. G02B 15/14

(52) U.S. Cl. CPC G02B 15/1461

(57) ABSTRACT

A zoom lens includes, in order from an object side to an image side, a first lens unit having positive refractive power, a second lens unit, a third lens unit, and a rear group including a plurality of lens units. A distance between adjacent lens units changes during zooming. During zooming from a wide-angle end to a telephoto end, the first lens unit moves toward the object side, a distance between the first lens unit and the second lens unit increases, a distance between the second lens unit and the third lens unit increases, and a distance between the third lens unit and the rear group increases. The rear group includes a focus lens unit having negative refractive power. The focus lens unit moves toward the object side during focusing from an object at infinity to an object at a close distance.

### BACKGROUND

### Technical Field The disclosure relates to a zoom lens suitable for imaging.

### Description of Related Art

As zoom lenses for imaging, so-called positive lead type zoom lenses are known, which include a lens unit having positive refractive power disposed closest to an object and can meet the requirements of a reduced size and weight, and a few fluctuations in optical performance during focusing.

Japanese Patent Laid-Open No. 2022-092388 discloses a zoom lens that includes a first lens unit having positive refractive power disposed closest to an object, wherein a distance between adjacent lens units changes during zooming.

In general, a telephoto type power arrangement at a telephoto end, high positive refractive power on the object side, and high negative refractive power on the image side are effective to the size reduction of the zoom lens. However, the high refractive power of each lens unit increases the fluctuations of various aberrations along with zooming, and it becomes difficult to satisfactorily correct various aberrations with a small number of lenses. Since an effective diameter of a lens unit on the object side increases in the positive lead type zoom lens, the configuration of the lens unit on the object side for weight reduction is important.

In the telephoto type zoom lens, a moving amount of a focus lens unit is likely to increase during focusing. Thus, the arrangement of the focus lens unit is important in order to suppress fluctuations in optical performance during focusing.

### SUMMARY

A zoom lens according to one aspect of the disclosure includes, in order from an object side to an image side, a first lens unit having positive refractive power, a second lens unit, a third lens unit, and a rear group including a plurality of lens units. A distance between adjacent lens units changes during zooming. During zooming from a wide-angle end to a telephoto end, the first lens unit moves toward the object side, a distance between the first lens unit and the second lens unit increases, a distance between the second lens unit and the third lens unit increases, and a distance between the third lens unit and the rear group increases. The rear group includes a focus lens unit having negative refractive power. The focus lens unit moves toward the object side during focusing from an object at infinity to an object at a close distance. An image pickup apparatus having the above zoom lens also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of a zoom lens according to Example 1.

FIGS. 2A and 2B are aberration diagrams of the zoom lens according to Example 1.

FIGS. 3A and 3B are other aberration diagrams of the zoom lens according to Example 1.

FIG. 4 is a sectional view of a zoom lens according to Example 2.

FIGS. 5A and 5B are aberration diagrams of the zoom lens according to Example 2.

FIGS. 6A and 6B are other aberration diagrams of the zoom lens according to Example 2.

FIG. 7 is a sectional view of a zoom lens according to Example 3.

FIGS. 8A and 8B are aberration diagrams of the zoom lens according to Example 3.

FIGS. 9A and 9B are other aberration diagrams of the zoom lens according to Example 3.

FIG. 10 is a sectional view of a zoom lens according to Example 4.

FIGS. 11A and 11B are aberration diagrams of the zoom lens according to Example 4.

FIGS. 12A and 12B are other aberration diagrams of the zoom lens according to Example 4.

FIG. 13 is a sectional view of a zoom lens according to Example 5.

FIGS. 14A and 14B are aberration diagrams of the zoom lens according to Example 5.

FIGS. 15A and 15B are other aberration diagrams of the zoom lens according to Example 5.

FIG. 16 is a sectional view of a zoom lens according to Example 6.

FIGS. 17A and 17B are aberration diagrams of the zoom lens according to Example 6.

FIGS. 18A and 18B are other aberration diagram of the zoom lens according to Example 6.

FIG. 19 is a schematic diagram of an image pickup apparatus having the zoom lens according to any one of Examples 1 to 6.

### DETAILED DESCRIPTION

Referring now to the accompanying drawings, a description will be given according to Examples according to the disclosure.

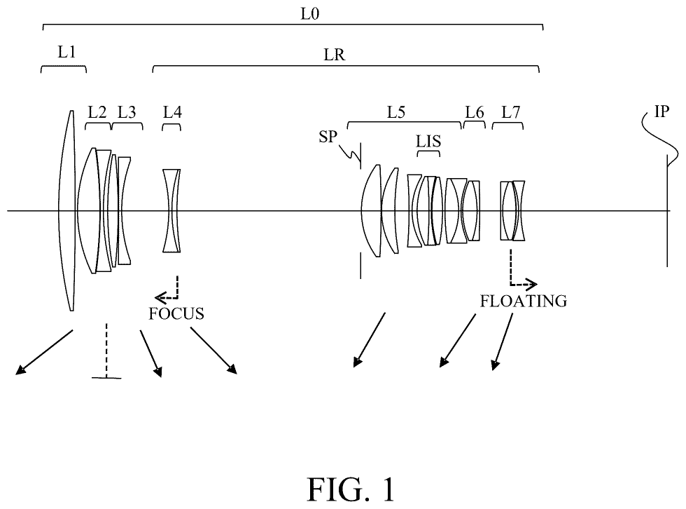

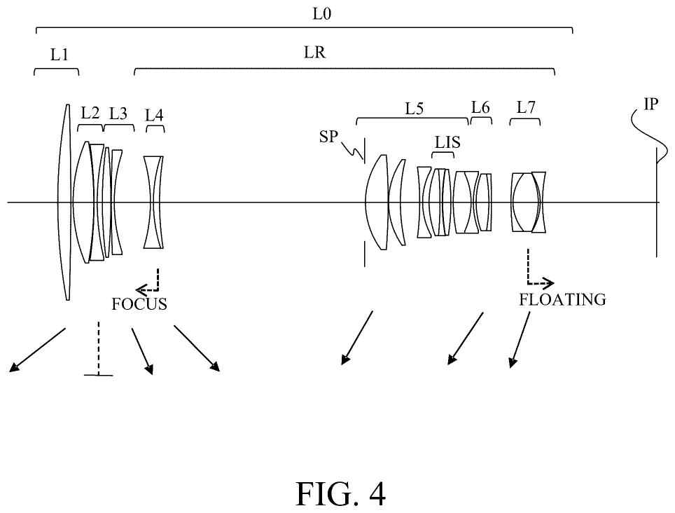

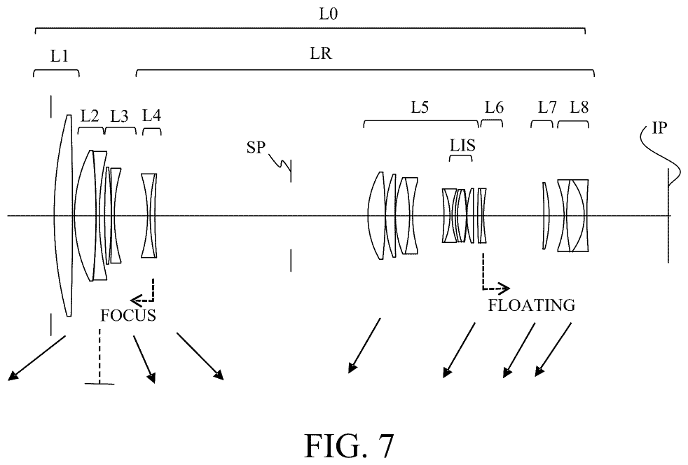

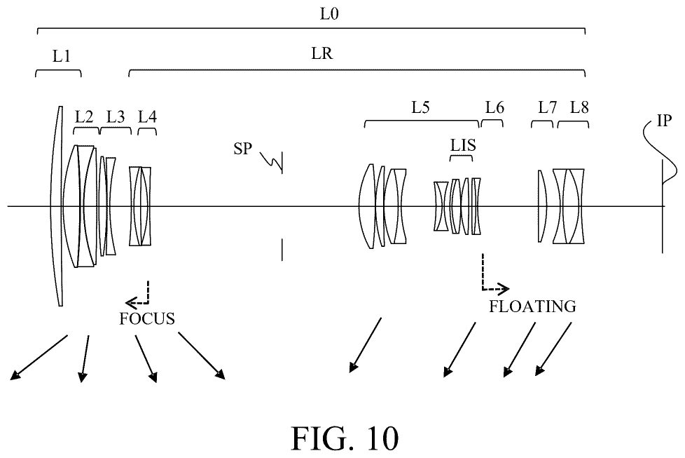

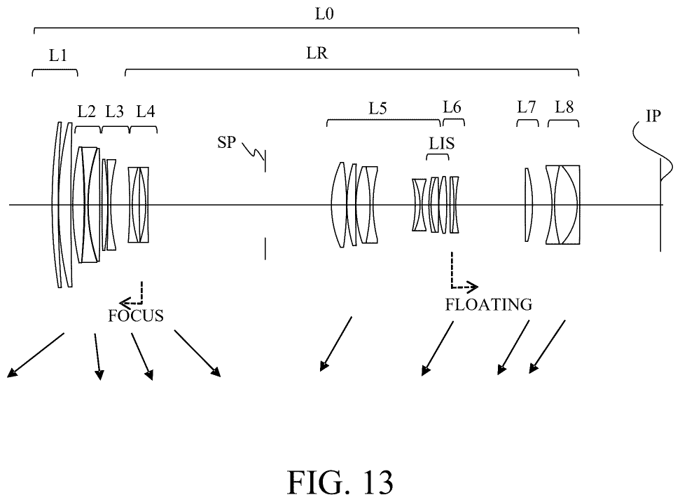

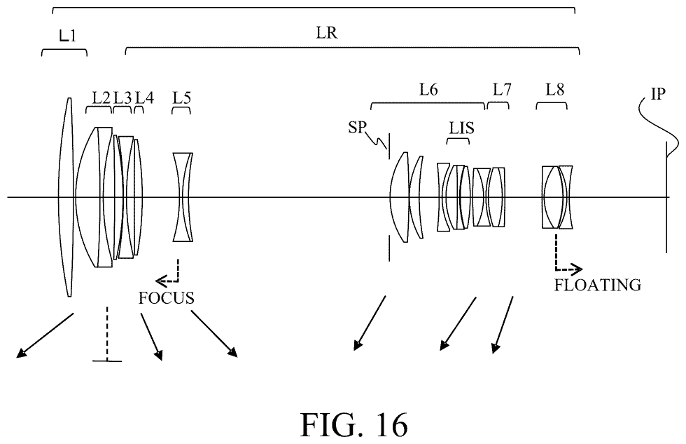

FIGS. 1, 4, 7, 10, 13, and 16 illustrate sections of zoom lens L0 according to Examples 1 to 6 at the wide-angle end in an in-focus state on an object at infinity (hereinafter, referred to as “in an in-focus state at infinity”). The zoom lens L0 according to each Example is used for optical apparatuses including interchangeable lenses and image pickup apparatuses, such as digital video cameras, digital still cameras, broadcasting cameras, film-based cameras, and surveillance cameras. It can also be used for observation optical apparatuses, such as telescopes.

In each sectional view, a left side is an object side (front side), and a right side is an image side (rear side). The zoom lens L0 according to each Example includes a plurality of lens units, each having refractive power. In a zoom lens, a lens unit is a group of one or more lenses that move together during magnification variation (zooming) between the wide-angle end and the telephoto end. That is, a distance between adjacent lens units changes during zooming. The lens unit may include an aperture stop (diaphragm). The wide-angle end and the telephoto end respectively indicate a maximum angle of view (shortest focal length) and a minimum angle of view (longest focal length) when the lens unit that moves during zooming is located at both ends of a mechanically or controllably movable range on the optical axis. Refractive power is a reciprocal of a focal length.

In each sectional view, Li represents an i-th lens unit when counting from the object side, among the lens units included in the zoom lens L0. LR is a rear group including all lens units disposed on the image side of the third lens unit L3. LIS is an image stabilizing unit that has a function (image stabilizing function) of correcting image blur caused by camera shake or the like by moving in a direction including a directional component perpendicular to the optical axis. The image stabilizing unit may be an entire lens unit or a subgroup that is a part of the lens unit. The subgroup is a group of one or more lenses whose configuration length (a distance from the surface closest to the object to the surface closest to the image plane of the subgroup) does not change (is fixed) during zooming.

SP represents an aperture stop. IP represent an image plane. Placed on the image plane IP is an imaging surface (light receiving surface) of a solid-state image sensor (photoelectric conversion element) such as a CCD sensor or a CMOS sensor, or a film surface (photosensitive surface) of a silver film. An optical element such as a parallel plate or a prism that does not have refractive power, such as a low-pass filter or an infrared cut filter, may be provided between the image plane IP and a lens disposed closest to the image plane of the zoom lens L0.

In each sectional view, a solid arrow below a lens unit configured to move during zooming illustrates a simplified moving locus of the lens unit during zooming from the wide-angle end to the telephoto end. A dashed arrow below a focus lens unit configured to move during focusing illustrates a moving direction of the lens unit during focusing from an object at infinity to an object at a close distance.

A description will now be given of features common to the zoom lens L0 according to each example. The zoom lens L0 according to each example is a positive lead type zoom lens in which the first lens unit L1 has positive refractive power. The zoom lens L0 according to each example includes, in order from the object side to the image side, a first lens unit L1 having positive refractive power, a second lens unit L2, a third lens unit L3, and a rear group LR including a plurality of lens units. The rear group LR includes all lens units (a fourth lens unit L4 to a seventh lens unit L7 or eighth lens unit L8) disposed on the image side of the third lens unit L3.

In the zoom lens L0 according to each example, during zooming from the wide-angle end to the telephoto end, the first lens unit L1 moves toward the object side, a distance between the first lens unit L1 and the second lens unit L2 increases, a distance between the second lens unit L2 and the third lens unit L3 increases, and a distance between the third lens unit L3 and the rear group LR increases. This results in a telephoto type power arrangement at the telephoto end, which is beneficial to the overall length reduction of the zoom lens L0.

Generally, as the focal length of a zoom lens at the telephoto end increases, the size of the first lens unit having positive refractive power is likely to increase. This is because an incident height of an on-axis light ray for a lens closer to an object at the telephoto end becomes higher, and an effective diameter (a radius of an area through which the light rays that contribute to imaging pass) increases. Thus, increasing the distance from the first lens unit can easily reduce the effective diameter, and thereby the weight of the zoom lens. This is because the volume (mass) of the lens is approximately proportional to the cube of the effective diameter.

In this regard, in the zoom lens L0 according to each example, a distance from the first lens unit L1 in the rear group LR increases at the telephoto end, so the diameter is likely to reduce.

The rear group LR includes a focus lens unit having negative refractive power. The focus lens unit moves toward the object side during focusing from an object at infinity to an object at a close distance. The focus lens unit as the part of the rear group LR can easily achieve its reduced size and weight, and quick focusing. Because the rear group LR has a small change in incident height of the on-axis light ray, and the focus lens as the part of the rear group LR can easily reduce aberration fluctuations during focusing.

In the zoom lens L0 according to each example, during zooming from the wide-angle end to the telephoto end, a distance between the focus lens unit and the lens unit adjacent to the focus lens unit on the object side increases, and during focusing from an object at infinity to an object at a close distance, the focus lens unit moves toward the object side. Thereby, a drive mechanism for zooming can be used as a drive mechanism for focusing, and the drive mechanism can become simple, and efficiently changing a distance between the lens units promotes the size reduction of the zoom lens.

The rear group LR may include a single focus lens unit, but the zoom lens L0 according to each example includes a first focus lens unit (FOCUS) as a main focus lens unit having negative refractive power, and a second focus lens unit (FLOATING) as a floating group disposed on the image side of the first focus lens unit. The second focus lens unit moves independently of the first focus lens unit (i.e., on a different locus) during focusing.

The above configuration can achieve a zoom lens that has a reduced size and weight and a few fluctuations in optical performance during focusing.

The zoom lens L0 according to each example may satisfy at least one of the following inequalities (1) to (13):

$$4.4 \leq D 2 t / D 2 w \leq 15. \qquad ( 1 )$$

$$- 2.8 \leq fL 1 / fL 2 \leq 3. \qquad ( 2 )$$

$$0.15 \leq \vert ML 1 / TLw \vert \leq 0.9 \qquad ( 3 )$$

$$0.05 \leq \vert ML 3 / TLw \vert \leq 0.4 \qquad ( 4 )$$

$$0.05 \leq \vert ML 3 / ML 1 \vert \leq 0.8 \qquad ( 5 )$$

$$\vert ML 2 / ML 1 \vert \leq 0.2 \qquad ( 6 )$$

$$\vert ML 2 / ML 3 \vert \leq 0.4 \qquad ( 7 )$$

$$0.03 \leq Skw / fL 1 \leq 0.5 \qquad ( 8 )$$

$$0.2 \leq \vert MF 1 / MF 2 \vert \leq 5. \qquad ( 9 )$$

$$60 \leq vdL 1 Pave . \leq 99 \qquad ( 10 )$$

$$60 \leq vdL 2 Pave . \leq 99 \qquad ( 11 )$$

$$20 \leq vdL 2 Nave . \leq 45 \qquad ( 12 )$$

$$1.4 \leq ndG 1 \leq 1.7 \qquad ( 13 )$$

Inequality (1) defines a proper relationship between the on-axis distance D2w from the surface closest to the object (foremost surface) of the zoom lens L0 to the surface closest to the image plane of the second lens unit L2 at the wide-angle end, and the on-axis distance D2t from the foremost surface to the surface closest to the image plane of the second lens unit L2 at the telephoto end. Satisfying inequality (1) can reduce a total thickness of the first lens unit L1 and the second lens unit L2 at the wide-angle end, and reduce the effective diameter of the second lens unit L2 at the telephoto end. Thereby, the weight reduction of the zoom lens can be easily achieved. In a case where the distance D2t reduces such that D2t/D2w becomes lower than the lower limit of inequality (1), the effective diameter of the second lens unit L2 increases, and it becomes difficult to reduce the weight of the zoom lens L0. In a case where the distance D2t increases such that D2t/D2w becomes higher than the upper limit of inequality (1), it becomes difficult to reduce the size of the zoom lens L0 at the telephoto end.

Inequality (2) defines a proper relationship between the focal length fL1 of the first lens unit L1 and the focal length fL2 of the second lens unit L2. Satisfying inequality (2) can increase the refractive power of the first lens unit L1, and can easily correct chromatic aberration at the telephoto end. In a case where the focal length fL1 of the first lens unit L1 increases (refractive power reduces) so that fL1/fL2 becomes higher than the upper limit value or becomes lower than the lower limit value of inequality (2), it becomes difficult to correct chromatic aberration at the telephoto end.

Inequality (3) defines a proper relationship between the moving amount ML1 of the first lens unit L1 during zooming from the wide-angle end to the telephoto end and the overall optical length TLw of the zoom lens L0 at the wide-angle end. A moving amount of the lens unit during zooming from the wide-angle end to the telephoto end is a difference between positions on the optical axis of the lens unit at the wide-angle end and the telephoto end, and does not include a reciprocating moving amount, and a sign of the moving amount is positive when the lens unit is located closer to the image side at the telephoto end than at the wide-angle end. The overall optical length TLw is a distance on the optical axis from the foremost surface of the zoom lens L0 to the image plane IP. In a case where the moving amount ML1 of the first lens unit L1 reduces so that |ML1/TLw| becomes lower than the lower limit of inequality (3), it becomes difficult to secure a high magnification varying ratio. In a case where the moving amount ML1 of the first lens unit L1 increases so that |ML1/TLw| becomes higher than the upper limit of inequality (3), it becomes difficult to reduce the size of the zoom lens L0 at the telephoto end.

Inequality (4) defines a proper relationship between the moving amount ML3 of the third lens unit L3 during zooming from the wide-angle end to the telephoto end and the overall optical length TLw of the zoom lens L0 at the wide-angle end. In a case where the moving amount ML3 of the third lens unit L3 reduces so that |ML3/TLw| becomes lower than the lower limit of inequality (4), it becomes difficult to secure a high magnification variation ratio. In a case where the moving amount ML3 of the third lens unit L3 increases so that |ML3/TLw| becomes higher than the upper limit of inequality (4), it becomes difficult to reduce the size of the zoom lens L0 at the wide-angle end.

Inequality (5) defines a proper relationship between the moving amount ML1 of the first lens unit L1 and the moving amount ML3 of the third lens unit L3 during zooming from the wide-angle end to the telephoto end. In a case where the moving amount ML1 of the first lens unit L1 reduces so that |ML3/ML1| becomes lower than the lower limit of inequality (5), it becomes difficult to secure a high magnification varying ratio. In a case where the moving amount ML1 of the first lens unit L1 increases so that |ML3/ML1| becomes higher than the upper limit of inequality (5), it becomes difficult to reduce the size of the zoom lens L0 at the telephoto end.

Inequality (6) defines a proper relationship between the moving amount ML2 of the second lens unit L2 and the moving amount ML1 of the first lens unit L1 during zooming from the wide-angle end to the telephoto end. In a case where the moving amount ML2 of the second lens unit L2 increases so that |ML2/ML1| becomes higher than the upper limit of inequality (6), it becomes difficult to reduce the size of the zoom lens L0 at the wide-angle end.

Inequality (7) defines a proper relationship between the moving amount ML2 of the second lens unit L2 and the moving amount ML3 of the third lens unit L3 during zooming from the wide-angle end to the telephoto end. In a case where the moving amount ML2 of the second lens unit L2 increases so that |ML2/ML3| becomes higher than the upper limit of inequality (7), it becomes difficult to reduce the size of the zoom lens L0 at the wide-angle end.

Inequality (8) defines a proper relationship between the back focus Skw of the zoom lens L0 at the wide-angle end and the focal length fL1 of the first lens unit L1. In a case where the back focus Skw at the wide-angle end reduces so that Skw/fL1 becomes lower than the lower limit of inequality (8), it is difficult to place an optical element such as a low-pass filter near the image plane IP where the imaging surface of the image sensor is located. In a case where the back focus Skw increases so that Skw/fL1 becomes higher than the upper limit of inequality (8), the overall optical length of the zoom lens L0 at the wide-angle end increases, and it becomes difficult to reduce the size of the zoom lens L0.

Inequality (9) defines a proper relationship between the moving amount MF1 during focusing of the first focus lens unit from an object at infinity to an object at a close distance at the telephoto end and the moving amount MF2 during focusing of the second focus lens unit from the object at infinity to the object at the close distance at the telephoto end. A moving amount of a focus lens unit during focusing from an object at infinity to an object at a close distance is a difference between positions on the optical axis where the focus lens unit is in focus on the object at infinity and the object at the close distance, and does not include a reciprocating moving amount. A sign of the moving amount is positive when the position where the focus lens unit is in focus on the object at the close distance is closer to the object than the position where the focus lens unit is in focus on the object at infinity. In a case where the moving amount MF1 of the first focus lens unit reduces so that |MF1/MF2| becomes lower than the lower limit of inequality (9), it is difficult to suppress the fluctuation of spherical aberration and other aberrations during focusing. In a case where the moving amount MF1 of the first focus lens unit increases so that |MF1/MF2| becomes higher than the upper limit of inequality (9), the fluctuations of spherical aberration and other aberrations during focusing increase.

Inequality (10) defines a proper range for the average Abbe number νdL1Pave. based on the d-line of all positive lenses among at least one positive lens included in the first lens unit L1. In a case where νdL1Pave. becomes lower than the lower limit of inequality (10), it becomes difficult to correct longitudinal and lateral chromatic aberrations at the telephoto end. In a case where νdL1Pave. becomes higher than the upper limit of inequality (10), the dispersion of all positive lenses included in the first lens unit L1 reduces, and it becomes difficult to correct lateral chromatic aberration at the wide-angle end.

Inequality (11) defines a proper range for the average Abbe number νdL2Pave. based on the d-line of all positive lenses among at least one positive lens included in the second lens unit L2. In a case where νdL2Pave. becomes lower than the lower limit of inequality (11), it is difficult to correct longitudinal and lateral chromatic aberrations at the telephoto end. In a case where νdL2Pave. becomes higher than the upper limit of inequality (11), the dispersion of all the positive lenses included in the second lens unit L2 reduces, and it becomes difficult to correct lateral chromatic aberration at the wide-angle end.

Inequality (12) defines a proper range for the average value νdL2Nave. of the Abbe numbers based on the d-line of all the negative lenses among at least one negative lens included in the second lens unit L2. In a case where νdL2Nave. becomes lower than the lower limit of inequality (12), it is difficult to correct longitudinal and lateral chromatic aberrations at the wide-angle end. In a case where νdL2Nave. becomes higher than the upper limit of inequality (12), it is difficult to correct longitudinal and lateral chromatic aberrations at the telephoto end.

Inequality (13) defines a proper range of the refractive index ndG1 for the d-line of the positive lens G1 closest to the object in the first lens unit L1. In a case where ndG1 becomes lower than the lower limit of inequality (13), the curvature of the surface increases in order to obtain the necessary refractive power, and high-order spherical aberration occurs as a result. In a case where ndG1 becomes higher than the upper limit of inequality (13), it is beneficial to the size reduction of the first lens unit L1, but the refractive power increases, and it becomes difficult to simultaneously correct distortion in correcting spherical aberration.

Inequalities (1) to (13) may be replaced with inequalities (1a) to (13a) below:

$$4.5 \leq D 2 t / D 2 w \leq 14. \qquad ( 1 a )$$

$$- 2. \leq fL 1 / fL 2 \leq 2. \qquad ( 2 a )$$

$$0.2 \leq \vert ML 1 / TLw \vert \leq 0.8 \qquad ( 3 a )$$

$$0.07 \leq \vert ML 3 / TLw \vert \leq 0.3 \qquad ( 4 a )$$

$$0.1 \leq \vert ML 3 / ML 1 \vert \leq 0.7 \qquad ( 5 a )$$

$$\vert ML 2 / ML 1 \vert \leq 0.1 \qquad ( 6 a )$$

$$\vert ML 2 / ML 3 \vert \leq 0.3 \qquad ( 7 a )$$

$$0.04 \leq Skw / fL 1 \leq 0.4 \qquad ( 8 a )$$

$$0.25 \leq \vert MF 1 / MF 2 \vert \leq 4. \qquad ( 9 a )$$

$$63 \leq vdL 1 Pave . \leq 97 \qquad ( 10 a )$$

$$65 \leq vdL 2 Pave . \leq 97 \qquad ( 11 a )$$

$$23 \leq vdL 2 Nave . \leq 40 \qquad ( 12 a )$$

$$1.42 \leq ndG 1 \leq 1.65 \qquad ( 13 a )$$

Inequalities (1) to (13) may be replaced with inequalities (1b) to (13b) below:

$$4.6 \leq D 2 t / D 2 w \leq 13. \qquad ( 1 b )$$

$$- 1.5 \leq fL 1 / fL 2 \leq 1.5 \qquad ( 2 b )$$

$$0.25 \leq \vert ML 1 / TLw \vert \leq 0. 75 \qquad ( 3 b )$$

$$0.1 \leq \vert ML 3 / TLw \vert \leq 0.25 \qquad ( 4 b )$$

$$0.15 \leq \vert ML 3 / ML 1 \vert \leq 0.6 \qquad ( 5 b )$$

$$\vert ML 2 / ML 1 \vert \leq 0. 05 \qquad ( 6 b )$$

$$\vert ML 2 / ML 3 \vert \leq 0.2 \qquad ( 7 b )$$

$$0.05 \leq Skw / fL 1 \leq 0.3 \qquad ( 8 b )$$

$$0.3 \leq \vert MF 1 / MF 2 \vert \leq 3. \qquad ( 9 b )$$

$$65 \leq vdL 1 Pave . \leq 96 \qquad ( 10 b )$$

$$70 \leq vdL 2 Pave . \leq 96 \qquad ( 11 b )$$

$$25 \leq vdL 2 Nave . \leq 37 \qquad ( 12 b )$$

$$1.43 \leq ndG 1 \leq 1.6 \qquad ( 13 b )$$

A description will now be given of a configuration that may be satisfied by the zoom lens L0 according to each example.

The first lens unit L1 may include two or less single lenses. Thereby, the weight reduction of the first lens unit L1 can be promoted. In a case where there is one cemented lens in which a plurality of (e.g., two) lenses are cemented together, it is considered to include a plurality of lenses (two).

The second lens unit L2 may include three or less lenses. Thereby, the weight reduction of the second lens unit L2 can be promoted. The third lens unit L3 may include four or less lenses or three or less lenses. Thereby, the weight reduction of the third lens unit L3 can be promoted.

The first focus lens unit may include three or less lenses. Thereby, the weight reduction of the first focus lens unit can be promoted. The second focus lens unit may include three or less lenses. Thereby, the weight reduction of the second focus lens unit can be promoted.

The rear group LR may include an image stabilizing unit. The image stabilizing unit as some or a subgroup of the rear group LR can reduce the size of the image stabilizing unit, and facilitate the size reduction of the zoom lens.

The rear group LR may include three or more or four or more lens units, and a distance between adjacent lens units may change during zooming. Moving many lens units during zooming can suppress aberration fluctuation during zooming, and it becomes easy to secure a high magnification varying ratio.

The third lens unit L3 may move toward the image side during zooming from the wide-angle end to the telephoto end. Positioning the third lens unit L3 on the image side at the telephoto end can easily reduce the diameter and weight of the third lens unit L3.

The aperture stop SP may move independently of the third lens unit L3 (i.e., on a different locus) during zooming. Thereby, it becomes easy to reduce the diameter of the aperture stop SP, and finally the size of the zoom lens L0.

A description will now be given of a specific configuration of the zoom lens L0 according to each example. The zoom lenses L0 according to Examples 1 and 2 consist of a first lens unit L1, a second lens unit L2 having negative refractive power, a third lens unit L3 having positive refractive power, a fourth lens unit L4 having negative refractive power, a fifth lens unit L5 having positive refractive power, a sixth lens unit L6 having positive refractive power, and a seventh lens unit L7 having negative refractive power. The fourth lens unit L4 to the seventh lens unit L7 are included in the rear group LR. An aperture stop SP is disposed closest to the object in the fifth lens unit L5.

In the zoom lenses L0 according to Examples 1 and 2, during zooming from the wide-angle end to the telephoto end, the first lens unit L1 moves toward the object side, the second lens unit L2 does not move, and the third lens unit L3 and the fourth lens unit L4 move toward the image side. The fifth lens unit L5 to the seventh lens unit L7 move toward the object side. During focusing from an object at infinity to an object at a close distance, the fourth lens unit L4 as the first focus lens unit moves toward the object side, and the seventh lens unit L7 as the second focus lens unit moves toward the image side.

The zoom lens L0 according to Example 3 consists of a first lens unit L1, a second lens unit L2 having negative refractive power, a third lens unit L3 having negative refractive power, a fourth lens unit L4 having negative refractive power, a fifth lens unit L5 having positive refractive power, a sixth lens unit L6 having negative refractive power, a seventh lens unit L7 having positive refractive power, and an eighth lens unit L8 having negative refractive power. The fourth lens unit L4 to the eighth lens unit L8 are included in the rear group LR. An aperture stop SP is disposed between the fourth lens unit L4 and the fifth lens unit L5.

In the zoom lens L0 according to Example 3, during zooming from the wide-angle end to the telephoto end, the first lens unit L1 moves toward the object side, the second lens unit L2 does not move, the third lens unit L3 and the fourth lens unit L4 move toward the image side, and the fifth lens unit L5 to the eighth lens unit L8 move toward the object side. During focusing from an object at infinity to an object at a close distance, the fourth lens unit L4 as the first focus lens unit moves toward the object side, and the sixth lens unit L6 as the second focus lens unit moves toward the image side.

The zoom lens L0 according to Example 4 consists of the first lens unit L1, the second lens unit L2 having positive refractive power, the third lens unit L3 having positive refractive power, the fourth lens unit L4 having negative refractive power, the fifth lens unit L5 having positive refractive power, the sixth lens unit L6 having negative refractive power, the seventh lens unit L7 having positive refractive power, and the eighth lens unit L8 having negative refractive power. The fourth lens unit L4 to the eighth lens unit L8 are included in the rear group LR. An aperture stop SP is disposed between the fourth lens unit L4 and the fifth lens unit L5.

In the zoom lens L0 according to Example 4, during zooming from the wide-angle end to the telephoto end, the first lens unit L1 and the second lens unit L2 move toward the object side, the third lens unit L3 and the fourth lens unit L4 move toward the image side, and the fifth lens unit L5 to the eighth lens unit L8 move toward the object side. During focusing from an object at infinity to an object at a close distance, the fourth lens unit L4 as the first focus lens unit moves toward the object side, and the sixth lens unit L6 as the second focus lens unit moves toward the image side.

The zoom lens L0 according to Example 5 consists of a first lens unit L1, a second lens unit L2 having positive refractive power, a third lens unit L3 having negative refractive power, a fourth lens unit L4 having negative refractive power, a fifth lens unit L5 having positive refractive power, a sixth lens unit L6 having negative refractive power, a seventh lens unit L7 having positive refractive power, and an eighth lens unit L8 having negative refractive power. The fourth lens unit L4 to the eighth lens unit L8 are included in the rear group LR. An aperture stop SP is disposed between the fourth lens unit L4 and the fifth lens unit L5.

In the zoom lens L0 according to Example 5, during zooming from the wide-angle end to the telephoto end, the first lens unit L1 moves toward the object side, the second lens unit L2 to the fourth lens unit L4 move toward the image side, and the fifth lens unit L5 to the eighth lens unit L8 move toward the object side. During focusing from an object at infinity to an object at a close distance, the fourth lens unit L4 as the first focus lens unit moves toward the object side, and the sixth lens unit L6 as the second focus lens unit moves toward the image side.

The zoom lens L0 according to Example 6 consists of a first lens unit L1, a second lens unit L2 having negative refractive power, a third lens unit L3 having negative refractive power, a fourth lens unit L4 having positive refractive power, a fifth lens unit L5 having negative refractive power, a sixth lens unit L6 having positive refractive power, a seventh lens unit L7 having positive refractive power, and an eighth lens unit L8 having negative refractive power. The fourth lens unit L4 to the eighth lens unit L8 are included in the rear group LR. An aperture stop SP is disposed closest to the object in the sixth lens unit L6.

In the zoom lens L0 according to Example 6, during zooming from the wide-angle end to the telephoto end, the first lens unit L1 moves toward the object side, the second lens unit L2 does not move, the third lens unit L3 to the fifth lens unit L5 move toward the image side, and the sixth lens unit L6 to the eighth lens unit L8 move toward the object side. During focusing from an object at infinity to an object at a close distance, the fifth lens unit L5 as the first focus lens unit moves toward the object side, and the eighth lens unit L8 as the second focus lens unit moves toward the image side.

A description will now be given of numerical examples 1 to 6 corresponding to Examples 1 to 6, respectively. In the surface data according to each numerical example, a surface number i indicates the order of a surface when counted from the object side. r represents a radius of curvature of an i-th surface (mm), d represents a lens thickness or air gap (mm) on the optical axis between i-th and (i+1)-th surfaces, and nd represents a refractive index for the d-line of the optical material between i-th and (i+1)-th surfaces. νd represents an Abbe number based on the d-line of the optical material between i-th and (i+1)-th surfaces. The Abbe number νd based on the d-line is expressed as:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer lines.

d, a focal length (mm), F-number, and half angle of view (°) are all values in an in-focus state at infinity. BF represents a back focus (mm). The back focus is a distance on the optical axis from a surface of the zoom lens closest to an image plane (a final surface) to a paraxial image plane expressed in air equivalent length. An overall lens length is a distance on the optical axis from the frontmost surface of the zoom lens to the final surface plus the back focus, and corresponds to the overall optical length. WIDE, MIDDLE, and TELE represent a wide-angle end, an intermediate zoom position, and a telephoto end, respectively.

An asterisk “*” next to a surface number means that the surface has an aspheric shape. The aspheric shape is expressed by the following equation:

$$X = ( {h}^{2} / R ) / [ 1 + {[ 1 - ( 1 + K ) {( h / R )}^{2} ]}^{1 / 2} ] + A 4 \times {h}^{4} + A 6 \times {h}^{6} + A 8 \times {h}^{8} + A 10 \times {h}^{10} + A 12 \times {h}^{12} + A 14 \times {h}^{14}$$

where X is a displacement amount from a surface vertex in the optical axis direction, h is a height from the optical axis in a direction perpendicular to the optical axis, a light traveling direction is positive, R is a paraxial radius of curvature, K is a conic constant, and A4, A6, A8, A10, A12, and A14 are aspheric coefficients. “e±XX” in the conic constant and aspheric coefficients means “×10^{±XX}.”

Table 1 summarizes values for inequalities (1) to (13) for each numerical example. Numerical examples 1 to 6 satisfy inequalities (1) to (13).

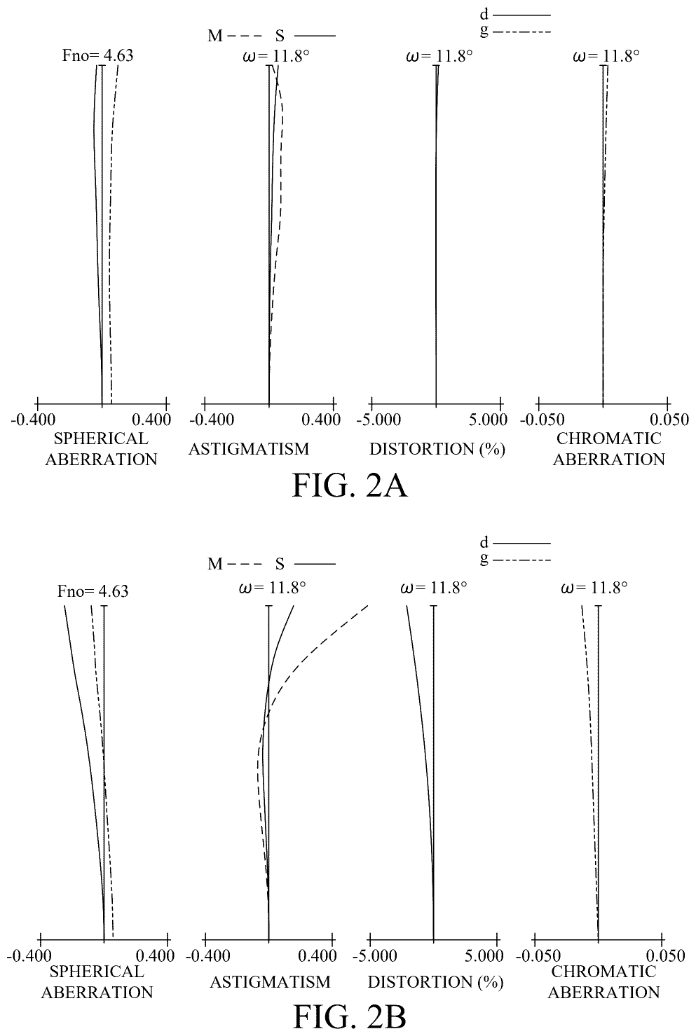

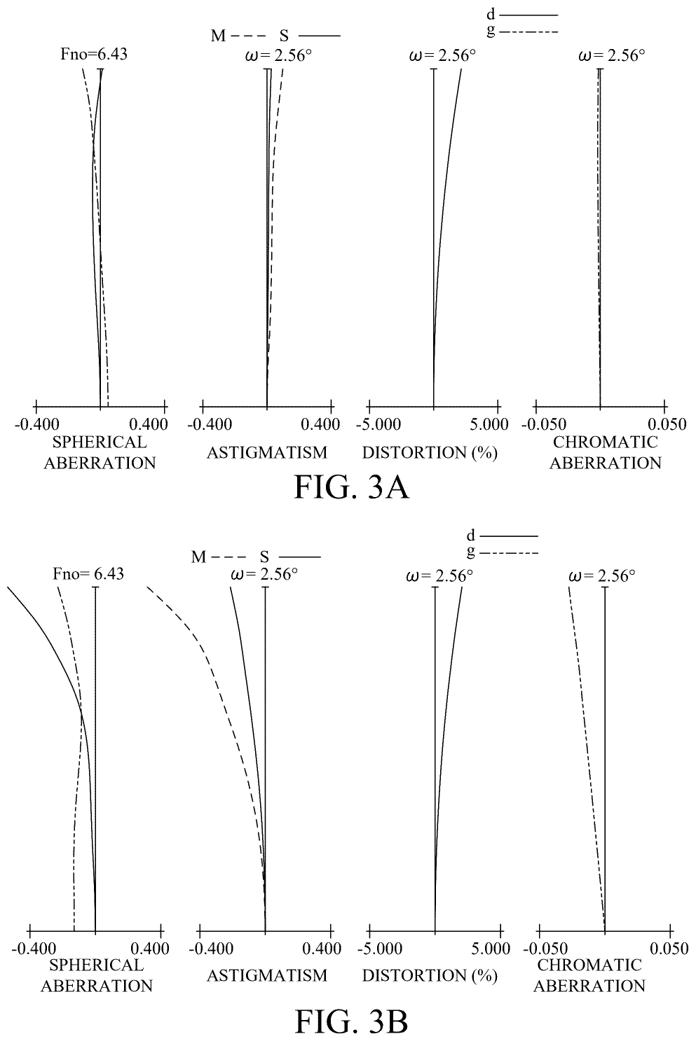

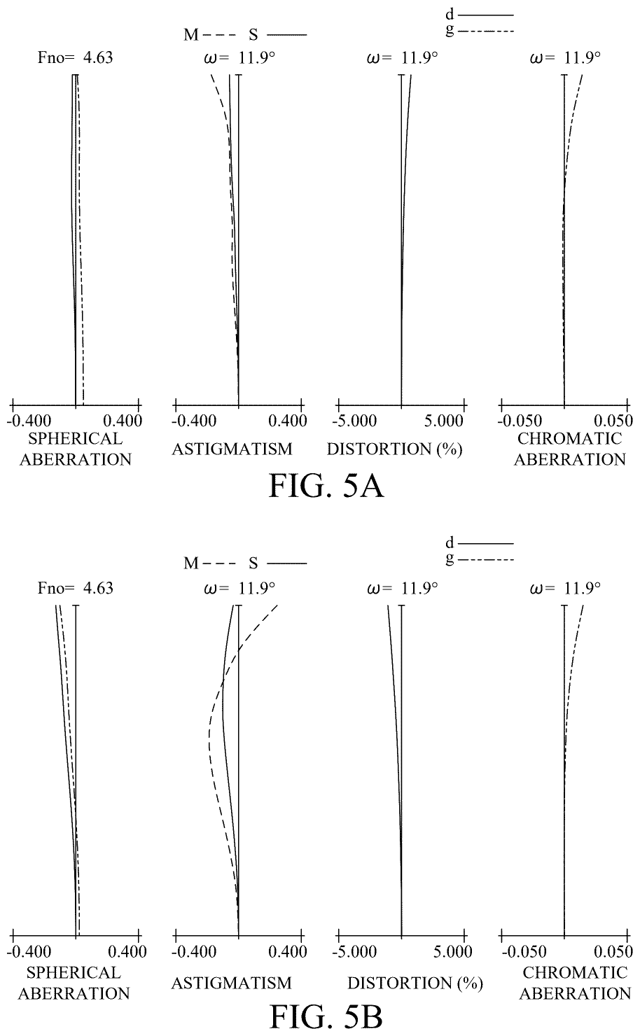

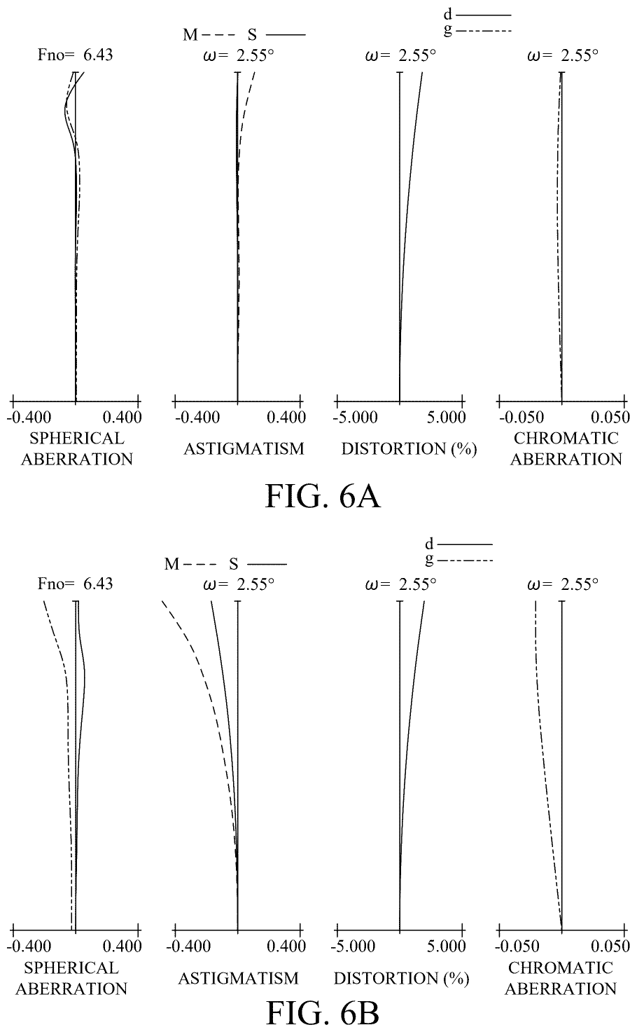

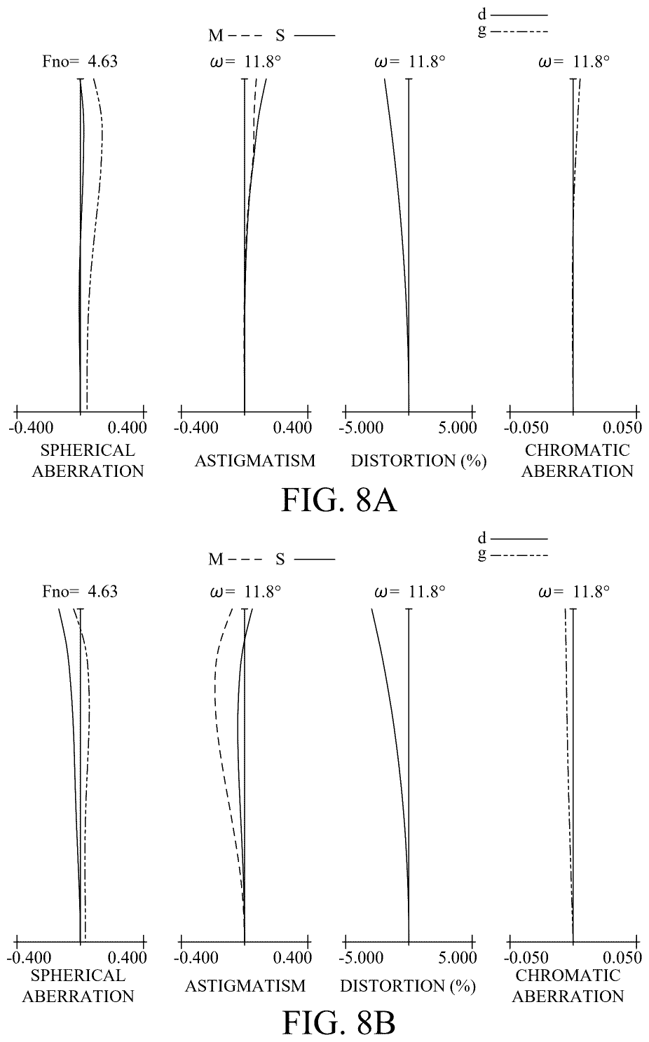

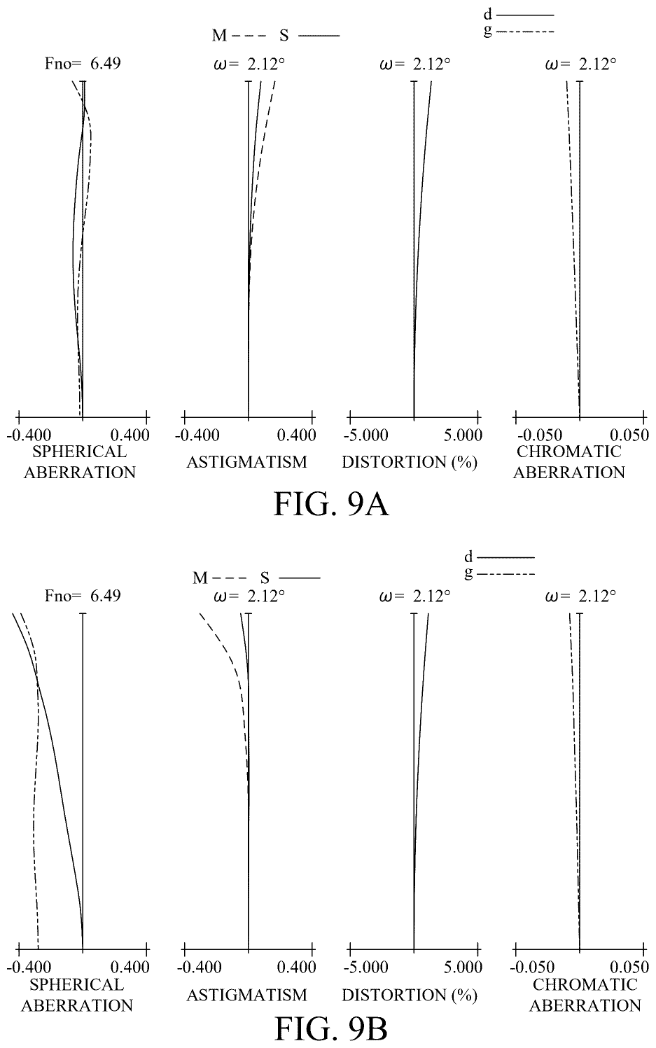

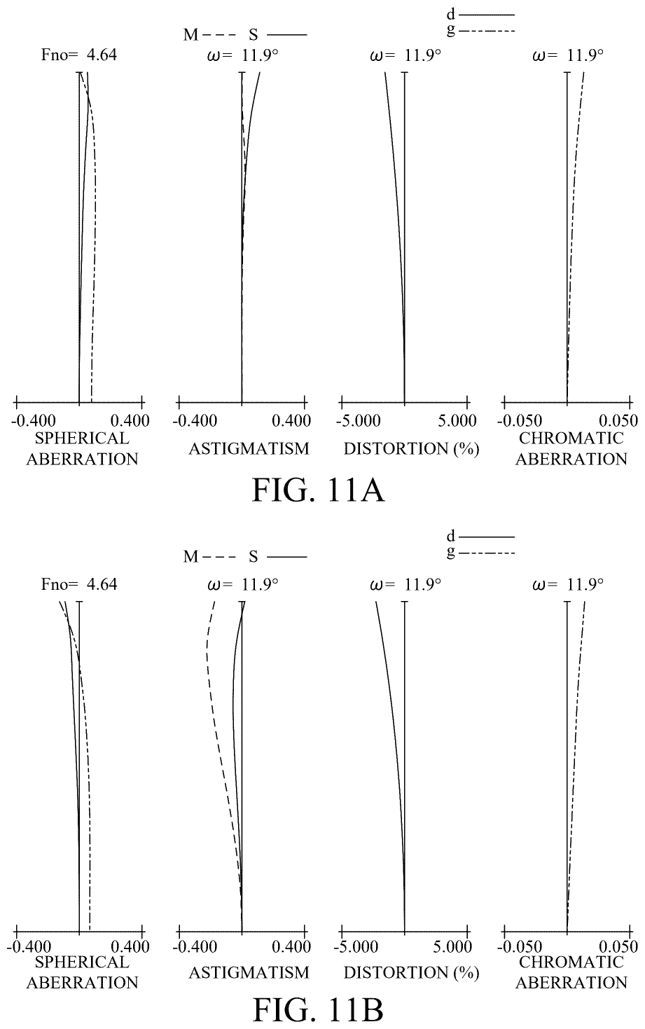

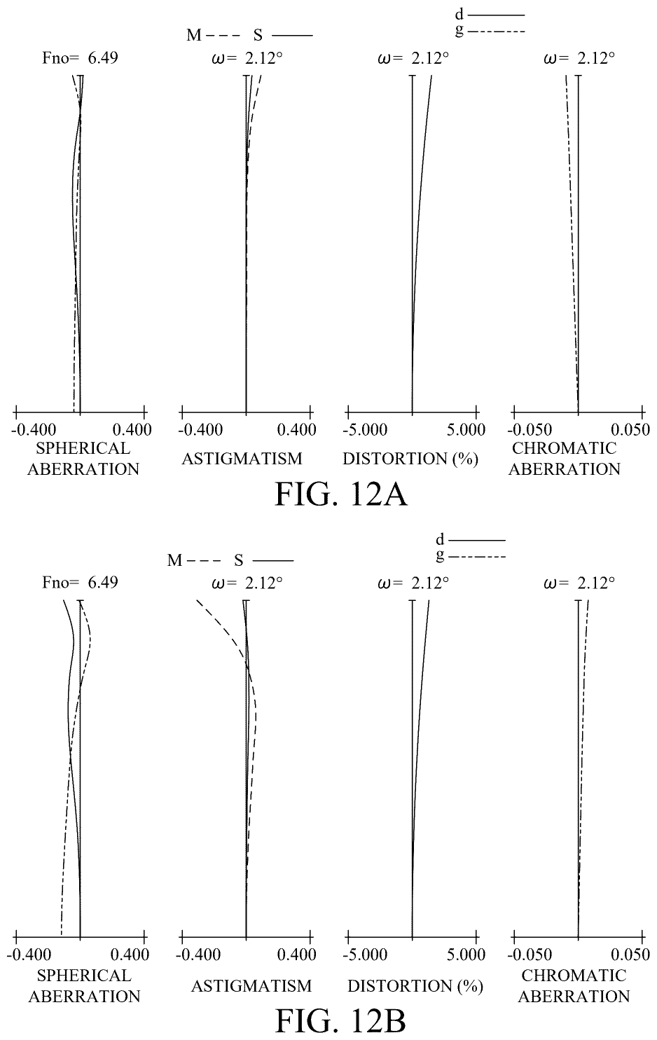

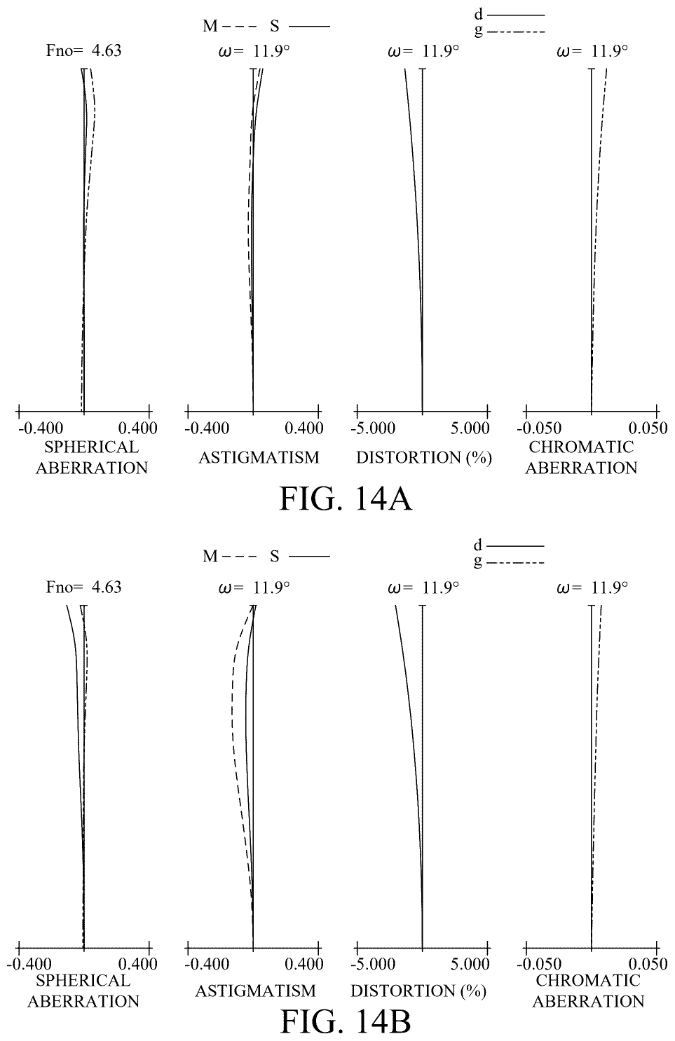

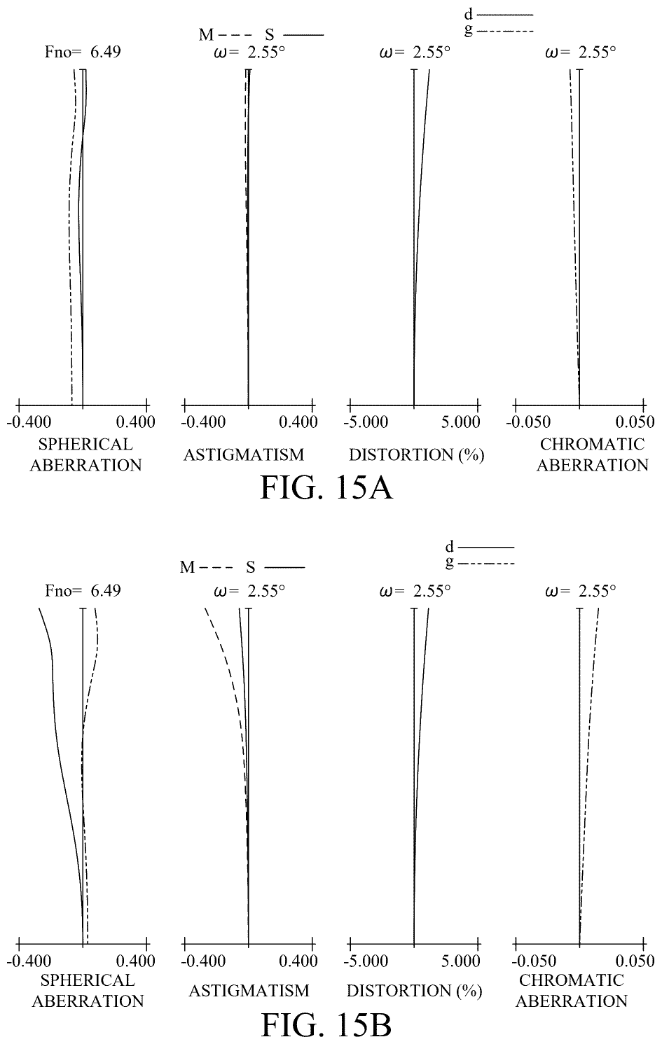

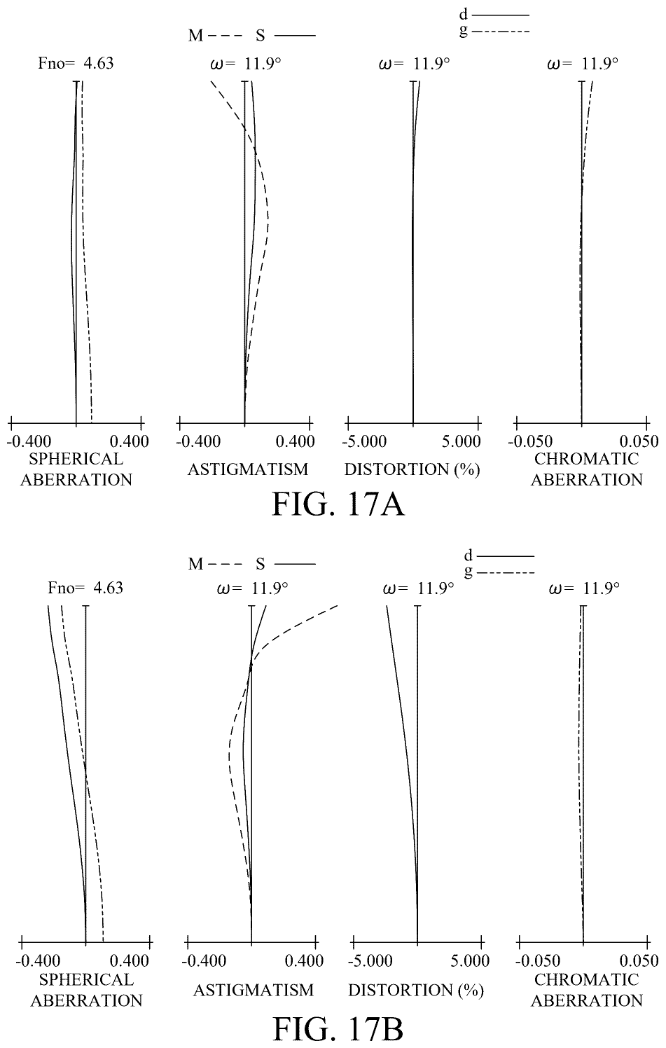

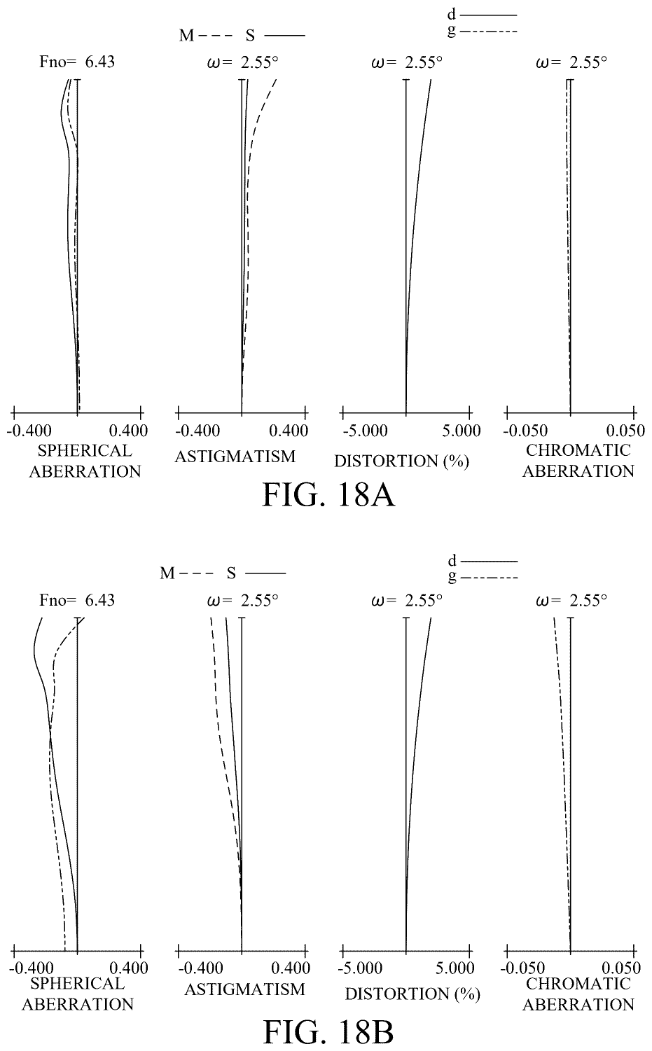

FIGS. 2A, 5A, 8A, 11A, 14A, and 17A illustrate the longitudinal aberrations (spherical aberration, astigmatism, distortion, and chromatic aberration) of the zoom lenses L0 according to numerical examples 1 to 6 at a wide-angle end in an in-focus state at infinity. FIGS. 2B, 5B, 8B, 11B, 14B, and 17B illustrate the longitudinal aberrations of the zoom lenses L0 according to numerical examples 1 to 6 at the wide-angle end in an in-focus state on an object at a close distance (hereinafter referred to as an in-focus state at a close distance). FIGS. 3A, 6A, 9A, 12A, 15A, and 18A illustrate longitudinal aberrations of the zoom lenses L0 according to numerical examples 1 to 6 at a telephoto end in an in-focus state at infinity. FIGS. 3B, 6B, 9B, 12B, 15B, and 18B illustrate longitudinal aberrations of the zoom lens L0 according to numerical examples 1 to 6 at the telephoto end in an in-focus state at a close distance.

In the spherical aberration diagram, Fno indicates the F-number. A solid line indicates a spherical aberration amount for the d-line (wavelength 587.6 nm), and an alternate long and two short dashes line indicates a spherical aberration amount for the g-line (wavelength 435.8 nm). In the astigmatism diagram, a solid line ΔS indicates an astigmatism amount on a sagittal image plane, and a dashed line ΔM indicates an astigmatism amount on a meridional image plane. The distortion diagram illustrates a distortion amount for the d-line. The chromatic aberration diagram illustrates a lateral chromatic aberration amount for the g-line. ω is a half angle of view (°) and indicates an angle of view calculated by paraxial calculation.

### NUMERICAL EXAMPLE 1

UNIT: mm
SURFACE DATA

| Surface No. | r | d | nd | νd |
|---|---|---|---|---|
| 1 | 164.651 | 6.49 | 1.49700 | 81.5 |
| 2 | −992.849 | (Variable) | | |
| 3 | 54.679 | 8.78 | 1.43387 | 95.1 |
| 4 | −164.854 | 0.10 | | |
| 5 | −177.402 | 1.25 | 1.77047 | 29.7 |
| 6 | 88.934 | (Variable) | | |
| 7 | 125.120 | 4.12 | 1.85478 | 24.8 |
| 8 | −202.791 | 0.15 | | |
| 9 | −3344.207 | 1.20 | 1.59282 | 68.6 |
| 10 | 57.245 | (Variable) | | |
| 11 | −55.760 | 1.20 | 1.59282 | 68.6 |
| 12 | 53.178 | 1.99 | 1.91650 | 31.6 |
| 13 | 102.063 | (Variable) | | |
| 14 (SP) | ∞ | 0.30 | | |
| 15 | 29.957 | 7.74 | 1.43387 | 95.1 |
| 16 | −327.003 | 0.15 | | |
| 17 | 28.976 | 5.20 | 1.49700 | 81.7 |
| 18 | 94.576 | 5.59 | | |
| 19 | −170.402 | 1.15 | 1.80610 | 40.7 |
| 20 | 25.369 | 1.99 | | |
| 21 | 30.481 | 4.64 | 1.49700 | 81.7 |
| 22 | −186.228 | 0.90 | 1.89286 | 20.4 |
| 23 | 53.091 | 0.10 | 1.58946 | 30.6 |
| 24* | 57.945 | 0.15 | | |
| 25 | 47.373 | 4.16 | 1.77047 | 29.7 |
| 26 | −71.660 | 0.95 | | |
| 27 | 86.275 | 5.37 | 1.89286 | 20.4 |
| 28 | −25.672 | 0.90 | 1.91082 | 35.2 |
| 29 | 29.058 | (Variable) | | |
| 30 | 28.044 | 5.65 | 1.72047 | 34.7 |
| 31 | −35.472 | 1.00 | 1.95906 | 17.5 |
| 32 | −370.146 | (Variable) | | |
| 33 | 1623.915 | 0.80 | 1.90043 | 37.4 |
| 34 | 28.414 | 5.20 | 1.66565 | 35.6 |
| 35 | −40.950 | 0.10 | 1.58946 | 30.6 |
| 36* | −40.526 | 0.91 | | |
| 37 | −30.022 | 0.90 | 1.49700 | 81.7 |
| 38 | 44.272 | (Variable) | | |
| Image Plane | ∞ | | | |

ASPHERIC DATA
24th Surface
K = 0.00000e+00 A 4 = 7.41455e−06 A 6 = 2.87737e−09
A 8 = −2.41337e−11 A10 = 1.40485e−13 A12 = −2.80246e−16
36th Surface
K = 0.00000e+00 A 4 = −3.89934e−06 A 6 = −1.16405e−08 A 8 =
2.43384e−10 A10 = −2.46472e−12 A12 = 9.07277e−15

VARIOUS DATA
ZOOM RATIO 4.70

| | WIDE | MIDDLE | TELE |
|---|---|---|---|
| Focal Length | 103.18 | 203.65 | 484.84 |
| Fno | 4.63 | 5.35 | 6.43 |
| Half Angle of View (°) | 11.84 | 6.06 | 2.56 |
| Image Height | 21.64 | 21.64 | 21.64 |
| Overall Lens Length | 238.21 | 282.76 | 337.21 |
| BF | 57.29 | 67.63 | 91.05 |
| d2 | 0.90 | 45.45 | 99.90 |
| d6 | 1.69 | 14.42 | 34.11 |
| d10 | 18.44 | 26.09 | 24.83 |
| d13 | 71.89 | 38.03 | 3.11 |
| d29 | 0.66 | 1.56 | 2.85 |
| d32 | 8.22 | 10.47 | 2.25 |
| d38 | 57.29 | 67.63 | 91.05 |

LENS UNIT DATA

| Lens Unit | Starting Surface | Focal Length |
|---|---|---|
| 1 | 1 | 284.69 |
| 2 | 3 | −530.88 |
| 3 | 7 | 1405.98 |
| 4 | 11 | −73.58 |
| 5 | 14 | 100.94 |
| 6 | 30 | 45.71 |
| 7 | 33 | −52.14 |

### NUMERICAL EXAMPLE 2

UNIT: mm
SURFACE DATA

| Surface No. | r | d | nd | νd |
|---|---|---|---|---|
| 1 | 215.133 | 5.22 | 1.43875 | 94.7 |
| 2 | −1177.812 | (Variable) | | |
| 3 | 61.606 | 8.31 | 1.43387 | 95.1 |
| 4 | −135.709 | 0.10 | | |
| 5 | −161.855 | 1.25 | 1.77047 | 29.7 |
| 6 | 94.133 | (Variable) | | |
| 7 | 165.786 | 3.43 | 2.00069 | 25.5 |
| 8 | −234.343 | 0.15 | | |
| 9 | 480.831 | 1.20 | 1.49700 | 81.7 |
| 10 | 63.848 | (Variable) | | |
| 11 | −62.530 | 1.20 | 1.59282 | 68.6 |
| 12 | 57.960 | 2.45 | 1.89190 | 37.1 |
| 13 | 117.437 | (Variable) | | |
| 14 (SP) | ∞ | 0.30 | | |
| 15 | 31.104 | 9.11 | 1.43387 | 95.1 |
| 16 | −229.645 | 0.15 | | |
| 17 | 29.443 | 4.72 | 1.49700 | 81.7 |
| 18 | 71.851 | 7.75 | | |
| 19 | −105.672 | 1.15 | 1.75500 | 52.3 |
| 20 | 26.867 | 2.59 | | |
| 21* | 34.801 | 4.37 | 1.49700 | 81.7 |
| 22 | −146.809 | 0.90 | 1.86966 | 20.0 |
| 23 | 74.586 | 0.15 | | |
| 24 | 78.321 | 3.30 | 1.80518 | 25.5 |
| 25 | −87.066 | 0.95 | | |
| 26 | 58.772 | 7.13 | 1.89286 | 20.4 |
| 27 | −26.869 | 0.90 | 1.96300 | 24.1 |
| 28 | 31.789 | (Variable) | | |
| 29 | 33.056 | 5.09 | 1.73037 | 32.2 |
| 30 | −68.071 | 1.00 | 1.95906 | 17.5 |
| 31 | −427.866 | (Variable) | | |
| 32 | 97.457 | 0.80 | 1.90043 | 37.4 |
| 33 | 17.340 | 10.09 | 1.60342 | 38.0 |
| 34 | −26.337 | 0.80 | | |
| 35* | −20.317 | 0.90 | 1.49700 | 81.7 |
| 36* | 51.161 | (Variable) | | |
| Image Plane | ∞ | | | |

ASPHERIC DATA
21st Surface
K = 0.00000e+00 A 4 = −4.85175e−06 A 6 = 9.97592e−10
A 8 = −1.83474e−11 A10 = 1.53669e−13 A12 = −4.61385e−16
35th Surface
K= 0.00000e+00 A 4 = 6.09133e−06 A 6 = 1.24869e−07
A 8 = −8.74896e−10 A10 = 2.74942e−12 A12 = 1.35020e−15
36th Surface
K= 0.00000e+00 A 4 = −1.34235e−05 A 6 = 9.27560e−08
A 8 = −8.88026e−10 A10 = 2.96304e−12 A12 = −2.48349e−15

VARIOUS DATA
ZOOM RATIO 4.71

| | WIDE | MIDDLE | TELE |
|---|---|---|---|
| Focal Length | 103.03 | 205.48 | 484.97 |
| Fno | 4.63 | 5.35 | 6.43 |
| Half Angle of View (°) | 11.86 | 6.01 | 2.55 |
| Image Height | 21.64 | 21.64 | 21.64 |
| Overall Lens Length | 239.52 | 312.59 | 401.90 |
| BF | 45.64 | 67.32 | 97.77 |
| d2 | 0.90 | 73.97 | 163.28 |
| d6 | 2.04 | 12.66 | 32.86 |
| d10 | 14.46 | 18.66 | 15.52 |
| d13 | 82.05 | 46.16 | 3.34 |
| d28 | 1.12 | 2.71 | 3.41 |
| d31 | 7.87 | 5.66 | 0.28 |
| d36 | 45.64 | 67.32 | 97.77 |

LENS UNIT DATA

| Lens Unit | Starting Surface | Focal Length |
|---|---|---|
| 1 | 1 | 415.08 |
| 2 | 3 | −442.00 |
| 3 | 7 | 273.06 |
| 4 | 11 | −83.51 |
| 5 | 14 | 107.00 |
| 6 | 29 | 47.56 |
| 7 | 32 | −52.06 |

### NUMERICAL EXAMPLE 3

UNIT: mm
SURFACE DATA

| Surface No. | r | d | nd | νd |
|---|---|---|---|---|
| 1 | 180.558 | 8.49 | 1.49700 | 81.5 |
| 2 | −1632.774 | (Variable) | | |
| 3 | 66.970 | 10.00 | 1.43387 | 95.1 |
| 4 | −292.843 | 0.03 | | |
| 5 | −331.366 | 1.45 | 1.80610 | 33.3 |
| 6 | 119.345 | (Variable) | | |
| 7 | 286.937 | 3.06 | 1.85478 | 24.8 |
| 8 | −196.659 | 0.15 | | |
| 9 | −658.113 | 1.25 | 1.59282 | 68.6 |
| 10 | 74.834 | (Variable) | | |
| 11 | −63.788 | 1.20 | 1.59282 | 68.6 |
| 12 | 87.224 | 2.18 | 1.77047 | 29.7 |
| 13 | 232.533 | (Variable) | | |
| 14 (SP) | ∞ | (Variable) | | |
| 15 | 39.833 | 8.03 | 1.43387 | 95.1 |
| 16 | −176.245 | 0.15 | | |
| 17 | 53.637 | 4.41 | 1.49700 | 81.5 |
| 18 | 777.726 | 0.15 | | |
| 19 | 47.028 | 6.56 | 1.49700 | 81.5 |
| 20 | −76.418 | 1.40 | 1.75500 | 52.3 |
| 21 | 55.274 | 14.53 | | |
| 22 | −98.263 | 2.73 | 1.66565 | 35.6 |
| 23 | −30.173 | 1.00 | 1.72916 | 54.7 |
| 24 | 34.552 | 1.50 | | |
| 25 | 52.362 | 1.00 | 1.95906 | 17.5 |
| 26 | 39.279 | 4.11 | 1.48749 | 70.2 |
| 27 | −61.481 | 0.10 | 1.58946 | 30.6 |
| 28* | −79.328 | 0.15 | | |
| 29 | 38.935 | 2.99 | 1.61340 | 44.3 |
| 30 | 789.408 | (Variable) | | |
| 31 | 237.194 | 1.92 | 1.77047 | 29.7 |
| 32 | −114.123 | 0.85 | 1.88300 | 40.8 |
| 33 | 68.900 | (Variable) | | |
| 34 | −257.247 | 2.43 | 1.56732 | 42.8 |
| 35 | −59.691 | (Variable) | | |
| 36 | −42.272 | 1.20 | 1.43875 | 94.7 |
| 37 | 88.047 | 8.14 | 1.51742 | 52.4 |
| 38 | −26.932 | 1.20 | 1.49700 | 81.5 |
| 39 | 218.375 | (Variable) | | |
| Image Plane | ∞ | | | |

ASPHERIC DATA
28th Surface
K = 0.00000e+00 A 4 = 6.76027e−07 A 6 = 2.49893e−09
A 8 = −2.91480e−11 A10 = 1.94933e−13 A12 = −4.85325e−16

VARIOUS DATA
ZOOM RATIO 5.66

| | WIDE | MIDDLE | TELE |
|---|---|---|---|
| Focal Length | 103.31 | 199.40 | 584.79 |
| Fno | 4.63 | 5.65 | 6.49 |
| Half Angle of View (°) | 11.83 | 6.19 | 2.12 |
| Image Height | 21.64 | 21.64 | 21.64 |
| Overall Lens Length | 284.16 | 346.98 | 389.09 |
| BF | 37.71 | 39.02 | 78.98 |
| d2 | 0.90 | 63.72 | 105.83 |
| d6 | 2.50 | 29.42 | 51.02 |
| d10 | 15.39 | 26.31 | 26.80 |
| d13 | 62.94 | 25.10 | 3.02 |
| d14 | 35.60 | 35.61 | −0.28 |
| d30 | 2.00 | 7.47 | 1.34 |
| d33 | 27.87 | 22.41 | 28.54 |
| d35 | 6.90 | 5.58 | 1.51 |
| d39 | 37.71 | 39.02 | 78.98 |

LENS UNIT DATA

| Lens Unit | Starting Surface | Focal Length |
|---|---|---|
| 1 | 1 | 327.63 |
| 2 | 3 | −1181.41 |
| 3 | 7 | −701.45 |
| 4 | 11 | −94.26 |
| 5 | 15 | 62.25 |
| 6 | 31 | −95.31 |
| 7 | 34 | 136.40 |
| 8 | 36 | −90.07 |

### NUMERICAL EXAMPLE 4

UNIT: mm
SURFACE DATA

| Surface No. | r | d | nd | νd |
|---|---|---|---|---|
| 1 | 269.981 | 4.95 | 1.59349 | 67.0 |
| 2 | 2061.875 | (Variable) | | |
| 3 | 77.510 | 7.78 | 1.43387 | 95.1 |
| 4 | −341.399 | 0.30 | | |
| 5 | −297.104 | 1.45 | 1.80610 | 33.3 |
| 6 | 79.900 | 0.14 | | |
| 7 | 81.238 | 6.06 | 1.43387 | 95.1 |
| 8 | −882.841 | (Variable) | | |
| 9 | 262.461 | 3.71 | 1.85478 | 24.8 |
| 10 | −157.690 | 0.15 | | |
| 11 | −573.290 | 1.25 | 1.59282 | 68.6 |
| 12 | 93.819 | (Variable) | | |
| 13 | −183.917 | 1.20 | 1.59282 | 68.6 |
| 14 | 65.292 | 3.13 | 1.66565 | 35.6 |
| 15 | 419.646 | 3.25 | | |
| 16 | −56.219 | 1.00 | 1.43875 | 94.7 |
| 17 | 387.874 | (Variable) | | |
| 18 (SP) | ∞ | (Variable) | | |
| 19 | 40.123 | 7.64 | 1.43387 | 95.1 |
| 20 | −178.847 | 0.15 | | |
| 21 | 60.169 | 3.76 | 1.59282 | 68.6 |
| 22 | 520.049 | 0.15 | | |
| 23 | 45.371 | 6.66 | 1.49700 | 81.7 |
| 24 | −76.645 | 1.40 | 1.72916 | 54.7 |
| 25 | 52.490 | 16.28 | | |
| 26 | −72.032 | 2.82 | 1.73037 | 32.2 |
| 27 | −25.361 | 1.00 | 1.74400 | 44.8 |
| 28 | 34.670 | 2.66 | | |
| 29 | 55.716 | 1.00 | 1.95906 | 17.5 |
| 30 | 39.268 | 4.08 | 1.48749 | 70.2 |
| 31* | −81.737 | 0.15 | | |
| 32 | 39.223 | 3.57 | 1.61340 | 44.3 |
| 33 | −276.942 | (Variable) | | |
| 34 | 463.197 | 1.89 | 1.68430 | 26.8 |
| 35 | −108.432 | 0.85 | 1.88300 | 40.8 |
| 36 | 65.081 | (Variable) | | |
| 37 | 4254.102 | 3.91 | 1.53172 | 48.8 |
| 38 | −50.478 | (Variable) | | |
| 39 | −41.498 | 1.20 | 1.43875 | 94.7 |
| 40 | 83.511 | 7.50 | 1.51742 | 52.4 |
| 41 | −35.690 | 1.20 | 1.43875 | 94.7 |
| 42 | 123.111 | (Variable) | | |
| Image Plane | ∞ | | | |

ASPHERIC DATA
31st Surface
K = 0.00000e+00 A 4 = 1.15289e−06 A 6 = −5.59256e−10 A 8 =
1.61123e−11 A10 = −4.37103e−14 A12 = −1.07538e−16

VARIOUS DATA
ZOOM RATIO 5.68

| | WIDE | MIDDLE | TELE |
|---|---|---|---|
| Focal Length | 103.05 | 193.32 | 584.97 |
| Fno | 4.64 | 5.65 | 6.49 |
| Half Angle of View (°) | 11.86 | 6.39 | 2.12 |
| Image Height | 21.64 | 21.64 | 21.64 |
| Overall Lens Length | 286.09 | 402.13 | 485.09 |
| BF | 37.92 | 39.96 | 76.42 |
| d2 | 0.90 | 116.88 | 199.78 |
| d8 | 0.98 | 21.47 | 40.59 |
| d12 | 10.07 | 20.63 | 31.69 |
| d17 | 61.89 | 30.90 | 0.78 |
| d18 | 35.94 | 34.48 | 2.19 |
| d33 | 1.45 | 4.25 | 1.49 |
| d36 | 28.37 | 25.57 | 28.33 |
| d38 | 6.33 | 5.74 | 1.57 |
| d42 | 37.92 | 39.96 | 76.42 |

LENS UNIT DATA

| Lens Unit | Starting Surface | Focal Length |
|---|---|---|
| 1 | 1 | 522.91 |
| 2 | 3 | 9459.33 |
| 3 | 9 | 722.28 |
| 4 | 13 | −78.06 |
| 5 | 19 | 62.32 |
| 6 | 34 | −71.94 |
| 7 | 37 | 93.85 |
| 8 | 39 | −90.25 |

### NUMERICAL EXAMPLE 5

UNIT: mm
SURFACE DATA

| Surface No. | r | d | nd | νd |
|---|---|---|---|---|
| 1 | 249.947 | 2.87 | 1.49700 | 81.7 |
| 2 | 506.076 | 0.15 | | |
| 3 | 159.697 | 5.81 | 1.43387 | 95.1 |
| 4 | 1509.843 | (Variable) | | |
| 5 | 125.288 | 5.34 | 1.49700 | 81.7 |
| 6 | −296.401 | 0.31 | | |
| 7 | −253.883 | 1.45 | 1.83400 | 37.2 |
| 8 | 84.599 | 0.15 | | |
| 9 | 83.338 | 5.44 | 1.59282 | 68.6 |
| 10 | −1443.043 | (Variable) | | |
| 11 | 631.408 | 2.73 | 1.85478 | 24.8 |
| 12 | −161.518 | 0.15 | | |
| 13 | −509.568 | 1.25 | 1.59282 | 68.6 |
| 14 | 87.535 | (Variable) | | |
| 15 | −221.759 | 1.20 | 1.59282 | 68.6 |
| 16 | 58.637 | 3.29 | 1.66565 | 35.6 |
| 17 | 426.730 | 3.01 | | |
| 18 | −56.885 | 1.00 | 1.49700 | 81.7 |
| 19 | 558.854 | (Variable) | | |
| 20 (SP) | ∞ | (Variable) | | |
| 21 | 47.779 | 7.14 | 1.43387 | 95.1 |
| 22 | −134.953 | 0.15 | | |
| 23 | 66.001 | 4.11 | 1.59282 | 68.6 |
| 24 | 804.355 | 0.15 | | |
| 25 | 54.394 | 6.63 | 1.49700 | 81.7 |
| 26 | −81.105 | 1.40 | 1.74400 | 44.8 |
| 27 | 65.118 | 19.81 | | |
| 28 | −55.737 | 2.26 | 1.74951 | 35.3 |
| 29 | −29.304 | 1.00 | 1.61997 | 63.9 |
| 30 | 37.868 | 3.17 | | |
| 31 | 62.476 | 1.00 | 1.96300 | 24.1 |
| 32 | 38.936 | 3.54 | 1.53775 | 74.7 |
| 33* | −381.530 | 0.15 | | |
| 34 | 46.452 | 3.70 | 1.65160 | 58.5 |
| 35 | −126.812 | (Variable) | | |
| 36 | 477.057 | 1.89 | 1.80810 | 22.8 |
| 37 | −111.706 | 0.85 | 1.88300 | 40.8 |
| 38 | 66.620 | (Variable) | | |
| 39 | 1273.663 | 3.44 | 1.51823 | 58.9 |
| 40 | −64.646 | (Variable) | | |
| 41 | −53.012 | 1.20 | 1.49700 | 81.7 |
| 42 | 71.145 | 10.67 | 1.51633 | 64.1 |
| 43 | −26.451 | 1.20 | 1.49700 | 81.7 |
| 44 | −1149.855 | (Variable) | | |
| Image Plane | ∞ | | | |

ASPHERIC DATA
33rd Surface
K = 0.00000e+00 A 4 = 1.40271e−06 A 6 = −2.47421e−10 A 8 =
1.80038e−11 A10 = −1.20178e−13 A12 = 2.66081e−16

VARIOUS DATA
ZOOM RATIO 4.71

| | WIDE | MIDDLE | TELE |
|---|---|---|---|
| Focal Length | 103.01 | 175.25 | 484.99 |
| Fno | 4.63 | 5.65 | 6.49 |
| Half Angle of View (°) | 11.86 | 7.04 | 2.55 |
| Image Height | 21.64 | 21.64 | 21.64 |
| Overall Lens Length | 286.01 | 334.52 | 365.98 |
| BF | 37.99 | 33.33 | 77.03 |
| d4 | 0.90 | 49.91 | 81.86 |
| d10 | 1.00 | 20.06 | 33.56 |
| d14 | 8.95 | 19.86 | 27.35 |
| d19 | 55.19 | 24.71 | 3.24 |
| d20 | 31.10 | 36.32 | −0.25 |
| d35 | 1.50 | 4.94 | 1.49 |
| d38 | 32.63 | 29.19 | 32.64 |
| d40 | 9.14 | 8.59 | 1.46 |
| d44 | 37.99 | 33.33 | 77.03 |

LENS UNIT DATA

| Lens Unit | Starting Surface | Focal Length |
|---|---|---|
| 1 | 1 | 291.18 |
| 2 | 5 | 9682.04 |
| 3 | 11 | −801.59 |
| 4 | 15 | −78.35 |
| 5 | 21 | 63.90 |
| 6 | 36 | −81.97 |
| 7 | 39 | 118.82 |
| 8 | 41 | −127.35 |

### NUMERICAL EXAMPLE 6

UNIT: mm
SURFACE DATA

| Surface No. | r | d | nd | νd |
|---|---|---|---|---|
| 1 | 197.124 | 5.90 | 1.49700 | 81.5 |
| 2 | −782.793 | (Variable) | | |
| 3 | 52.622 | 9.59 | 1.43875 | 94.7 |
| 4 | −417.306 | 1.25 | 1.77047 | 29.7 |
| 5 | 90.372 | (Variable) | | |
| 6 | −811.869 | 3.30 | 1.66565 | 35.6 |
| 7 | −111.574 | 0.15 | | |
| 8 | −147.836 | 1.20 | 1.59282 | 68.6 |
| 9 | 98.887 | (Variable) | | |
| 10 | 2234.164 | 3.14 | 1.76182 | 26.5 |
| 11 | −129.162 | (Variable) | | |
| 12 | −59.773 | 1.20 | 1.59282 | 68.6 |
| 13 | 50.104 | 2.35 | 1.95375 | 32.3 |
| 14 | 93.685 | (Variable) | | |
| 15 (SP) | ∞ | 0.30 | | |
| 16 | 30.767 | 7.44 | 1.43387 | 95.1 |
| 17 | −262.308 | 0.15 | | |
| 18 | 32.073 | 3.90 | 1.49700 | 81.7 |
| 19 | 86.891 | 7.86 | | |
| 20 | −124.894 | 1.15 | 1.80610 | 40.7 |
| 21 | 27.616 | 1.53 | | |
| 22 | 26.746 | 4.49 | 1.49700 | 81.7 |
| 23 | −422.814 | 0.90 | 1.89286 | 20.4 |
| 24 | 42.919 | 0.10 | 1.58946 | 30.6 |
| 25* | 50.472 | 0.15 | | |
| 26 | 45.722 | 3.93 | 1.77047 | 29.7 |
| 27 | −64.700 | 0.95 | | |
| 28 | 145.730 | 4.31 | 1.89286 | 20.4 |
| 29 | −25.519 | 0.90 | 1.91082 | 35.2 |
| 30 | 35.172 | (Variable) | | |
| 31 | 35.306 | 5.48 | 1.72047 | 34.7 |
| 32 | −42.894 | 1.00 | 1.95906 | 17.5 |
| 33 | −298.101 | (Variable) | | |
| 34 | 523.176 | 0.80 | 1.90043 | 37.4 |
| 35 | 20.681 | 7.38 | 1.66565 | 35.6 |
| 36 | −34.825 | 0.10 | 1.58946 | 30.6 |
| 37* | −38.323 | 1.49 | | |
| 38 | −24.141 | 0.90 | 1.49700 | 81.7 |
| 39 | 58.518 | (Variable) | | |
| Image Plane | ∞ | | | |

ASPHERIC DATA
25th Surface
K = 0.00000e+00 A 4 = 9.74936e−06 A 6 = 3.68108e−09 A 8 =
2.18763e−11 A10 = −2.63909e−13 A12 = 9.77618e−16
37th Surface
K = 0.00000e+00 A 4 = −9.37220e−06 A 6 = −2.15979e−08 A 8 =
1.80501e−10 A10 = −1.75052e−12 A12 = 5.97397e−15

VARIOUS DATA
ZOOM RATIO 4.70

| | WIDE | MIDDLE | TELE |
|---|---|---|---|
| Focal Length | 103.07 | 201.02 | 484.94 |
| Fno | 4.63 | 5.35 | 6.43 |
| Half Angle of View (°) | 11.85 | 6.14 | 2.55 |
| Image Height | 21.64 | 21.64 | 21.64 |
| Overall Lens Length | 239.60 | 284.15 | 338.60 |
| BF | 38.37 | 51.67 | 87.04 |
| d2 | 0.90 | 45.45 | 99.90 |
| d5 | 4.51 | 16.38 | 31.20 |
| d9 | 3.10 | 3.10 | 6.01 |
| d11 | 14.66 | 19.39 | 19.76 |
| d14 | 79.10 | 44.03 | 3.36 |
| d30 | 0.98 | 8.02 | 7.04 |
| d33 | 14.69 | 12.81 | 0.99 |
| d39 | 38.37 | 51.67 | 87.04 |

LENS UNIT DATA

| Lens Unit | Starting Surface | Focal Length |
|---|---|---|
| 1 | 1 | 317.48 |
| 2 | 3 | −2387.23 |
| 3 | 6 | −206.08 |
| 4 | 10 | 160.37 |
| 5 | 12 | −77.22 |
| 6 | 15 | 103.13 |
| 7 | 31 | 54.98 |
| 8 | 34 | −46.92 |

| | Numerical Example | | | | | |
|---|---|---|---|---|---|---|
| | 1 | 2 | 3 | 4 | 5 | 6 |
| D2w | 17.51 | 15.78 | 24.87 | 21.58 | 22.42 | 26.80 |
| D2t | 116.51 | 178.15 | 178.31 | 220.46 | 103.38 | 152.49 |
| fL1 | 284.69 | 415.08 | 327.63 | 522.91 | 291.18 | 317.48 |
| fL2 | −530.88 | −442.00 | −1181.41 | 9459.33 | 9682.04 | −2387.23 |
| TLw | 238.21 | 239.52 | 285.66 | 286.09 | 286.01 | 239.60 |
| ML1 | −99.00 | −162.38 | −104.93 | −199.00 | −79.97 | −99.00 |
| ML2 | 0.00 | 0.00 | 0.00 | −0.12 | 0.99 | 0.00 |
| ML3 | 32.42 | 30.82 | 48.52 | 39.49 | 33.54 | 26.69 |
| Skw | 57.29 | 45.64 | 37.71 | 37.92 | 37.99 | 38.37 |
| MF1 | −18.22 | −9.45 | −19.43 | −14.92 | −8.23 | −16.81 |
| MF2 | 21.60 | 25.95 | 26.02 | 25.97 | 25.91 | 26.07 |
| νdL1Pave. | 81.54 | 94.66 | 81.54 | 67.00 | 88.38 | 81.54 |
| νdL2Pave. | 95.10 | 95.10 | 95.10 | 95.10 | 75.14 | 94.66 |
| νdL2Nave. | 29.74 | 29.74 | 33.27 | 33.27 | 33.27 | 29.74 |
| ndG1 | 1.50 | 1.44 | 1.50 | 1.59 | 1.50 | 1.50 |

Inequality

| | | | | | | |
|---|---|---|---|---|---|---|
| (1) | 6.65 | 11.29 | 7.17 | 10.21 | 4.61 | 5.69 |
| (2) | −0.54 | −0.94 | −0.28 | 0.06 | 0.03 | −0.13 |
| (3) | 0.42 | 0.68 | 0.37 | 0.70 | 0.28 | 0.41 |
| (4) | 0.14 | 0.13 | 0.17 | 0.14 | 0.12 | 0.11 |
| (5) | 0.33 | 0.19 | 0.46 | 0.20 | 0.42 | 0.27 |
| (6) | 0.00 | 0.00 | 0.00 | 0.00 | 0.01 | 0.00 |
| (7) | 0.00 | 0.00 | 0.00 | 0.00 | 0.03 | 0.00 |
| (8) | 0.20 | 0.11 | 0.12 | 0.07 | 0.13 | 0.12 |
| (9) | 0.84 | 0.36 | 0.75 | 0.57 | 0.32 | 0.64 |
| (10) | 81.54 | 94.66 | 81.54 | 67.00 | 88.38 | 81.54 |
| (11) | 95.10 | 95.10 | 95.10 | 95.10 | 75.14 | 94.66 |
| (12) | 29.74 | 29.74 | 33.27 | 33.27 | 33.27 | 29.74 |
| (13) | 1.50 | 1.44 | 1.50 | 1.59 | 1.50 | 1.50 |

### Image Pickup Apparatus

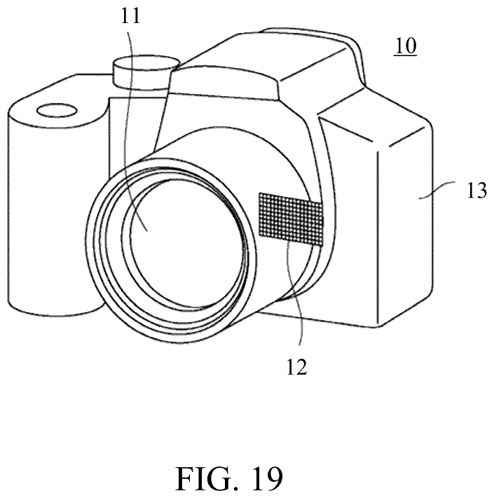

FIG. 19 illustrates an image pickup apparatus (digital still camera) 10 that uses the zoom lens L0 according to any one of Examples 1 to 6 as an imaging optical system. The image pickup apparatus 10 includes a camera body 13, a zoom lens 11 (L0) according to any one of Examples 1 to 6, and an image sensor 12 that photoelectrically converts (images) an optical image formed by the zoom lens 11.

The image pickup apparatus 10 includes a zoom lens 11 that has a reduced size and high optical performance and thus can obtain a high-quality captured image. Various aberrations such as distortion and chromatic aberration of a captured image acquired by the image sensor 12 may be electrically corrected.

### Imaging System

An imaging system, such as a surveillance camera system, may include the zoom lens L0 according to each example and a control unit configured to control the zoom lens L0. In this case, the control unit can control the zoom lens L0 so that each lens unit moves as described above during zooming, focusing, and image stabilization. In this case, the control unit does not need to be integrated with the zoom lens L0, and may be separated from the zoom lens L0. For example, a configuration may be adopted in which a control apparatus as a control unit disposed remotely from a drive unit that drives each lens of the zoom lens L0 includes a transmission unit that sends a control signal (command) for controlling the zoom lens L0. Due to this control unit, the zoom lens L0 can be remotely operated.

A configuration may be adopted in which an operation unit such as a controller or button for remotely operating the zoom lens L0 is provided in the control unit, thereby controlling the zoom lens L0 according to a user input to the operation unit. For example, a magnification button and a reduction button may be provided as the operation unit. In this case, the control unit may transmit a signal to the drive unit in the zoom lens L0 so that in a case where the user presses the magnification button, the magnification of the zoom lens L0 increases, and in a case where the user presses the reduction button, the magnification of the zoom lens L0 decreases.

The imaging system may have a display unit such as a liquid crystal panel that displays information on the zoom of the zoom lens L0. The information on the zoom includes the zoom magnification (zoom state), a moving amount (movement state) of each lens unit, and the like. In this case, the user can remotely operate the zoom lens L0 via the operation unit while viewing the information on the zoom of the zoom lens L0 displayed on the display unit. In this case, the display unit and the operation unit may be integrated by adopting a touch panel.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide a zoom lens that has a reduced size and weight, and a few fluctuations in optical performance during focusing.

This application claims priority to Japanese Patent Application No. 2023-206073, which was filed on Dec. 6, 2023, and which is hereby incorporated by reference herein in its entirety.

What is claimed is:

1. A zoom lens comprising, in order from an object side to an image side:
a first lens unit having positive refractive power;
a second lens unit;
a third lens unit; and
a rear group including a plurality of lens units,
wherein a distance between adjacent lens units changes during zooming,
wherein during zooming from a wide-angle end to a telephoto end, the first lens unit moves toward the object side, a distance between the first lens unit and the second lens unit increases, a distance between the second lens unit and the third lens unit increases, and a distance between the third lens unit and the rear group increases,
wherein the rear group includes a focus lens unit having negative refractive power, and
wherein the focus lens unit moves toward the object side during focusing from an object at infinity to an object at a close distance.

2. The zoom lens according to claim 1, wherein the following inequality is satisfied:
$$4. 4 \leq D 2 t / D 2 w \leq 15.$$
where D2w is an on-axis distance from a surface closest to an object of the zoom lens to a surface closest to an image plane of the second lens unit at the wide-angle end, and D2t is an on-axis distance from the surface closest to the object of the zoom lens to the surface closest to the image plane of the second lens unit at the telephoto end.

3. The zoom lens according to claim 1, wherein the following inequality is satisfied:
$$- 2.8 \leq fL 1 / fL 2 \leq 3.$$
where fL1 is a focal length of the first lens unit, and fL2 is a focal length of the second lens unit.

4. The zoom lens according to claim 1, wherein the rear group includes three or more lens units, and
wherein a distance between adjacent lens units in the rear group changes during zooming.

5. The zoom lens according to claim 1, wherein the following inequality is satisfied:
$$0.15 \leq \vert ML1 / TLw \vert \leq 0. 90$$
wherein ML1 is a moving amount of the first lens unit during zooming from the wide-angle end to the telephoto end, and TLw is an overall optical length of the zoom lens at the wide-angle end.

6. The zoom lens according to claim 1, wherein the following inequality is satisfied:
$$0.05 \leq \vert ML3 / TLw \vert \leq 0. 40$$
where ML3 is a moving amount of the third lens unit during zooming from the wide-angle end to the telephoto end, and TLw is an overall optical length of the zoom lens at the wide-angle end.

7. The zoom lens according to claim 1, wherein the following inequality is satisfied:
$$0.05 \leq \vert ML 3 / ML 1 \vert \leq 0. 80$$
where ML1 is a moving amount of the first lens unit during zooming from the wide-angle end to the telephoto end, and ML3 is a moving amount of the third lens unit during zooming from the wide-angle end to the telephoto end.

8. The zoom lens according to claim 1, wherein the following inequality is satisfied:
$$\vert ML2 / ML 1 \vert \leq 0. 20$$
where ML2 is a moving amount of the second lens unit during zooming from the wide-angle end to the telephoto end, and ML1 is a moving amount of the first lens unit during zooming from the wide-angle end to the telephoto end.

9. The zoom lens according to claim 1, wherein the following inequality is satisfied:
$$\vert ML 2 / ML 3 \vert \leq 0. 40$$
where ML2 is a moving amount of the second lens unit during zooming from the wide-angle end to the telephoto end, and ML3 is a moving amount of the third lens unit during zooming from the wide-angle end to the telephoto end.

10. The zoom lens according to claim 1, wherein the following inequality is satisfied:
$$0.03 \leq Skw / fL 1 \leq 0.5$$
where Skw is a back focus of the zoom lens at the wide-angle end, and fL1 is a focal length of the first lens unit.

11. The zoom lens according to claim 1, wherein the rear group includes, as the focus lens unit, a first focus lens unit, and a second focus lens unit disposed on the image side of the first focus lens unit and configured to move during focusing, and
wherein the following inequality is satisfied:
$$0.2 \leq \vert MF 1 / MF 2 \vert \leq 5.$$
where MF1 is a moving amount of the first focus lens unit during focusing from the object at infinity to the object at the close distance at the telephoto end, and MF2 is a moving amount of the second focus lens unit during focusing from the object at infinity to the object at the close distance at the telephoto end.

12. The zoom lens according to claim 1, wherein the first lens unit includes at least one positive lens, and the following inequality is satisfied:
$$60 \leq vdL 1 Pave . \leq 99$$
where νdL1Pave is an average Abbe number based on d-line of all positive lenses included in the first lens unit.

13. The zoom lens according to claim 1, wherein the second lens unit includes at least one positive lens, and the following inequality is satisfied:
$$60 \leq vdL 2 Pave . \leq 99$$
where νdL2Pave. is an average Abbe number based on d-line of all positive lenses included in the second lens unit.

14. The zoom lens according to claim 1, wherein the second lens unit includes at least one negative lens, and the following inequality is satisfied:
$$20 \leq vdL 2 Nave . \leq 45$$
where νdL2Nave. is an average Abbe number based on d-line of all negative lenses included in the second lens unit.

15. The zoom lens according to claim 1, wherein the first lens unit includes at least one positive lens, and the following inequality is satisfied:
$$1.4 \leq ndG 1 \leq 1.7$$
where ndG1 is a refractive index for d-line of a positive lens disposed closest to the object among the at least one positive lens.

16. The zoom lens according to claim 1, wherein the first lens unit consists of two or less single lenses.

17. The zoom lens according to claim 1, wherein the second lens unit consists of three or less lenses.

18. The zoom lens according to claim 1, wherein the third lens unit consists of four or less lenses.

19. The zoom lens according to claim 11, wherein the first focus lens unit consists of three or less lenses.

20. The zoom lens according to claim 11, wherein the second focus lens unit consists of three or less lenses.

21. The zoom lens according to claim 1, wherein at least a part of one of the plurality of lens units included in the rear group is an image stabilizing unit configured to move relative to an optical axis to reduce image blur.

22. The zoom lens according to claim 1, wherein the third lens unit moves toward the image side during zooming from the wide-angle end to the telephoto end.

23. The zoom lens according to claim 1, wherein the rear group includes an aperture stop that moves independently of the third lens unit during zooming.

24. The zoom lens according to claim 1, comprising in order from the object side to the image side:
the first lens unit;
the second lens unit having negative refractive power;
the third lens unit having positive refractive power;
a fourth lens unit having negative refractive power;
a fifth lens unit having positive refractive power;
a sixth lens unit having positive refractive power; and
a seventh lens unit having negative refractive power,
wherein the number of lens units in the zoom lens is seven.

25. The zoom lens according to claim 1, comprising, in order from the object side to the image side:
the first lens unit;
the second lens unit having negative refractive power;
the third lens unit having negative refractive power;
a fourth lens unit having negative refractive power;
a fifth lens unit having positive refractive power;
a sixth lens unit having negative refractive power;
a seventh lens unit having positive refractive power; and
an eighth lens unit having negative refractive power, wherein the number of lens units in the zoom lens is eight.

26. The zoom lens according to claim 1, comprising, in order from the object side to the image side:
the first lens unit;
the second lens unit having positive refractive power;
the third lens unit having positive refractive power;
a fourth lens unit having negative refractive power;
a fifth lens unit having positive refractive power;
a sixth lens unit having negative refractive power;
a seventh lens unit having positive refractive power; and
an eighth lens unit having negative refractive power,
wherein the number of lens units in the zoom lens is eight.

27. The zoom lens according to claim 1, comprising, in order from the object side to the image side:
the first lens unit;
the second lens unit having positive refractive power;
the third lens unit having negative refractive power;
a fourth lens unit having negative refractive power;
a fifth lens unit having positive refractive power;
a sixth lens unit having negative refractive power;
a seventh lens unit having positive refractive power; and
an eighth lens unit having negative refractive power,
wherein the number of lens units in the zoom lens is eight.

28. The zoom lens according to claim 1, comprising, in order from the object side to the image side:
the first lens unit;
the second lens unit having negative refractive power;
the third lens unit having negative refractive power;
a fourth lens unit having positive refractive power;
a fifth lens unit having negative refractive power;
a sixth lens unit having positive refractive power;
a seventh lens unit having positive refractive power; and
an eighth lens unit having negative refractive power,
wherein the number of lens units in the zoom lens is eight.

29. An image pickup apparatus comprising:
a zoom lens; and
an image sensor configured to capture an object image through the zoom lens,
wherein the zoom lens includes, in order from an object side to an image side:
a first lens unit having positive refractive power;
a second lens unit;
a third lens unit; and
a rear group including a plurality of lens units,
wherein a distance between adjacent lens units changes during zooming,
wherein during zooming from a wide-angle end to a telephoto end, the first lens unit moves toward the object side, a distance between the first lens unit and the second lens unit increases, a distance between the second lens unit and the third lens unit increases, and a distance between the third lens unit and the rear group increases,
wherein the rear group includes a focus lens unit having negative refractive power, and
wherein the focus lens unit moves toward the object side during focusing from an object at infinity to an object at a close distance.
